(19) United States
(12) Patent Application Publication
(10) Pub. No.: US 2017/0362425 A1
(43) Pub. Date: Dec. 21, 2017

(54) High Performance Surfactant Free Latexes for Improved Water Resistance

(71) Applicant: RHODIA OPERATIONS, Paris (FR)

(72) Inventors: Adnan SIDDIQUI, Tenafly, NJ (US); Pierre-Emmanuel DUFILS, Paris (FR); David James WILSON, Coye la Forte (FR); Tiffany CHEN, Newark (DE)

(73) Assignee: RHODIA OPERATIONS, Paris (FR)

(21) Appl. No.: 15/623,603

(22) Filed: Jun. 15, 2017

Related U.S. Application Data
(60) Provisional application No. 62/350,374, filed on Jun. 15, 2016.

(51) Int. Cl. C08L 31/04; C09D 7/00; C09D 5/14; C09D 131/04

(52) U.S. Cl. CPC C08L 31/04; C09D 131/04; C09D 7/001; C09D 5/14; C08L 2201/52

(57) ABSTRACT

Coatings and other applications containing a latex with modified surface properties obtainable by methods of adding a water soluble amphiphilic copolymer in a aqueous dispersion of a water-insoluble polymer obtained from ethylenically unsaturated monomers.

### CROSS-REFERENCE TO RELATED APPLICATIONS

This application claims the benefit of U.S. Provisional Application Ser. No. 62/350,374, filed Jun. 15, 2016, incorporated herein by reference in its entirety.

### FIELD OF THE INVENTION

This invention relates to improved coatings having reduced surfactant levels, latexes free or substantial free of surfactant, and which have improved properties including but not limited to water resistance and, in particular, to improved latexes prepared by utilizing hydrophilic precursors with a Xanthate moiety (or other chain-transfer agent or “CTA”) in emulsion polymerization without the need for emulsifying surfactants.

### BACKGROUND OF THE INVENTION

Latexes are colloidal dispersions of polymer particles in water, produced by emulsion polymerization. Latexes are used in a broad range of applications, and offers considerable advantages for industrial synthesis. They represent an attractive alternative to solvent-based formulations. However, several drawbacks remain associated with traditional latex-based coatings and processes, mainly due to the presence of surfactants in the resulting polymer. Surfactants typically are utilized during emulsion polymerization (EP), which is crucial role in the formation of emulsion polymer latexes. Typical emulsifying surfactants include anionic surfactants, nonionic surfactants, amphoteric surfactants, and zwitterionic surfactants. Examples of anionic emulsifying surfactants (otherwise known as “surfactant emulsifiers”) are the alkali metal alkyl aryl sulfonates, the alkali metal alkyl sulfates and the sulfonated alkyl esters. Other examples of well-known emulsifiers include sodium dodecyl benzene sulfonate, sodium dodecyl butylnaphthalene sulfonate, sodium lauryl sulfate, disodium dodecyl diphenyl ether disulfonate, disodium n-octadecyl sulfosuccinamate and sodium dioctyl sulfosuccinate.

However, once the latex is made, surfactants that remain are detrimental in the final application. When exposed to water or high humidity, surfactants negatively impact the properties of the resulting films by migrating toward the interfaces. For example, the effects can sometime be seen as the film becoming hazy. The negative effects include corrosion, defects in the film such as leaching or blistering, blooming or blushing, which reduce the gloss or induce whitening if the surfactants clusters are swollen with water.

### SUMMARY OF INVENTION

Latexes, as described herein, are made without the use of a surfactant, but by inducing molecular self-assembly of polymeric emulsifier particles prepared by RAFT. In another embodiment, latexes, as described herein, are made with little or no added surfactant, but by inducing molecular self-assembly of polymeric emulsifier particles prepared by RAFT.

It has been surprisingly discovered that standard latexes can be prepared through emulsion polymerization of in particular hydrophilic monomers can be performed directly in batch or semi batch and conditions using water-soluble/water dispersible macro-RAFT/MADIX agents. In such conditions, amphiphilic block copolymers form and self-assemble into self-stabilized particles within the course of the polymerization by polymerization-induced self-assembly (PISA). This process solves the problems met during the attempts to implement RAFT/MADIX in ab initio emulsion such as loss of molecular weight control, loss of colloidal stability, and/or formation of an intractable oily layer. The PISA process allows the synthesis of latexes without using low molecular weight surfactants avoiding the problems induced by these products.

It has been also demonstrated that the nano-objects obtained during polymerization by PISA may give polymer films that resist to water due to strong hydrogen bonding between the hydrophilic blocks, even after 72 hours of immersion.

Low molar mass surfactants are essential to stabilize latexes utilizing traditional processes, but they can have detrimental effects on the latex stability when frozen or subjected to high shear. When exposed to water or high humidity, surfactants can also negatively impact the properties of the resulting films by migrating toward the interfaces. They can induce corrosion, defects in the film, reduce the gloss or induce whitening if the surfactants clusters are swollen with water. Polymerization Induced Self-Assembly used in the process to prepare latexes, however, allows the preparation of latexes without molecular surfactant, by using hydrophilic macromolecular chain transfer agents instead. Despite the use of these hydrophilic compounds, the resulting obtained for these latexes showed an improvement of water resistance.

Latex is an example of an emulsion polymer which is a water based polymer dispersion. Latex paints are used for a variety of applications including interior and exterior, and flat, semi-gloss and gloss applications. Latex is a stable dispersion (colloidal emulsion) of rubber or plastic polymer microparticles in an aqueous medium. Latexes may be natural or synthetic.

The at least one latex polymer in the aqueous coating composition can be a pure acrylic, a styrene acrylic, a vinyl acrylic or an acrylated ethylene vinyl acetate copolymer and is more preferably a pure acrylic. The at least one latex polymer is preferably derived from at least one acrylic monomer selected from the group consisting of acrylic acid, acrylic acid esters, methacrylic acid, and methacrylic acid esters. For example, the at least one latex polymer can be a butyl acrylate/methyl methacrylate copolymer or a 2-ethylhexyl acrylate/methyl methacrylate copolymer. Typically, the at least one latex polymer is further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C4-C8 conjugated dienes.

The aqueous coating composition, in one embodiment, includes at least one pigment. The term “pigment” as used herein includes non-film-forming solids such as pigments, extenders, and fillers. The at least one pigment is preferably selected from the group consisting of TiO2 (in both anastase and rutile forms), clay (aluminum silicate), CaCO3 (in both ground and precipitated forms), aluminum oxide, silicon dioxide, magnesium oxide, talc (magnesium silicate), barytes (barium sulfate), zinc oxide, zinc sulfite, sodium oxide, potassium oxide and mixtures thereof. Suitable mixtures include blends of metal oxides such as those sold under the marks MINEX (oxides of silicon, aluminum, sodium and potassium commercially available from Unimin Specialty Minerals), CELITES (aluminum oxide and silicon dioxide commercially available from Celite Company), ATOMITES (commercially available from English China Clay International), and ATTAGELS (commercially available from Engelhard). More preferably, the at least one pigment includes TiO2, CaCO3 or clay. Generally, the mean particle sizes of the pigments range from about 0.01 to about 50 microns. For example, the TiO2 particles used in the aqueous coating composition typically have a mean particle size of from about 0.15 to about 0.40 microns. The pigment can be added to the aqueous coating composition as a powder or in slurry form. The pigment is preferably present in the aqueous coating composition in an amount from about 5 to about 50 percent by weight, more preferably from about 10 to about 40 percent by weight.

The coating composition can optionally contain additives such as one or more film-forming aids or coalescing agents. Suitable firm-forming aids or coalescing agents include plasticizers and drying retarders such as high boiling point polar solvents. Other conventional coating additives such as, for example, dispersants, additional surfactants (i.e. wetting agents), rheology modifiers, defoamers, thickeners, additional biocides, additional mildewcides, colorants such as colored pigments and dyes, waxes, perfumes, co-solvents, and the like, can also be used in accordance with the invention. For example, non-ionic and/or ionic (e.g. anionic or cationic) surfactants can be used to produce the polymer latex. These additives are typically present in the aqueous coating composition in an amount from 0 to about 15% by weight, more preferably from about 1 to about 10% by weight based on the total weight of the coating composition.

Compositions of the present invention may have an absence of one or more of anionic surfactant, cationic surfactant, nonionic surfactant, zwitterionic surfactant, and/or amphoteric surfactant.

According to one aspect, described herein are aqueous compositions comprising:

water;

optionally, a pigment; and

a film-forming latex composition with modified surface chemistry obtained by free-radical emulsion polymerization in the presence:

of at least one ethylenically unsaturated monomer or at least one polymer containing residual ethylenically unsaturated bonds,

of at least one free-radical polymerization initiator, and

of at least one water-soluble and/or water-dispersible polymer of formula (Ia) or formula (Ib):

(R¹¹)x-Z¹¹—C(═S)—Z¹²-[A]-[B]-R¹² (Ia), or

(R¹¹)x-Z¹¹—C(═S)—Z¹²-[B]-R¹² (Ib)

wherein:

Z¹¹ represents C, N, O, S or P,

Z¹² represents S or P,

R¹¹ and R¹², which may be identical or different, represent:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii),

these groups (1) rings (i) or heterocycles (iii) being optionally substituted with substituted phenyl groups, substituted aromatic groups or groups selected from:
alkoxycarbonyl or aryloxycarbonyl (—COOR) groups,
carboxyl (—COOH) groups,
acyloxy (—O₂CR) groups,
carbamoyl (—CONR₂) groups,
cyano (—CN) groups,
alkylcarbonyl groups,
alkylarylcarbonyl groups,
arylcarbonyl groups,
arylalkylcarbonyl groups,
phthalimido groups,
maleimido groups,
succinimide groups,
amidino groups,
guanidimo groups,
hydroxyl (—OH) groups,
amino (—NR₂) groups,
halogen groups,
allyl groups,
epoxy groups,
alkoxy (—OR) groups,
S-alkyl groups,
S-aryl groups,
alkali metal salts of carboxylic acids,
alkali metal salts of sulphonic acid,
polyalkylene oxide (PEO or PPO) chains, and
quaternary ammonium salts,
   wherein R represents an alkyl or aryl group,

x corresponds to the valency of Z¹¹, or alternatively x is 0, in which case Z¹¹ represents a phenyl, alkene or alkyne radical, being optionally substituted with groups selected from:

an optionally substituted alkyl, acyl, aryl, alkene or alkyne group, an optionally substituted, saturated, unsaturated, or aromatic, carbon-based ring, an optionally substituted, saturated or unsaturated heterocycle; an alkoxycarbonyl or aryloxycarbonyl (—COOR) group,
a carboxyl (COOH) group,
an acyloxy (—O₂CR) group,
a carbamoyl (—CONR₂) group,
a cyano (—CN) group;
an alkylcarbonyl group;
an alkylarylcarbonyl group;
an arylcarbonyl group;
an arylalkylcarbonyl group;
a phthalimido group,
a maleimido group,
a succinimido group,
a amidino group,
a guanidimo group,
a hydroxyl (—OH) group,
an amino (—NR₂) group,
a halogen group,
an allyl group,
an epoxy group,
an alkoxy (—OR) group,
a S-alkyl group,
a S-aryl group,
an alkali metal salt of carboxylic acid,
an alkali metal salt of sulphonic acid,
polyalkylene oxide (PEO or PPO) chains, and
quaternary ammonium salts,
   wherein R represents an alkyl or aryl group;

A is a monoblock, diblock or triblock polymer comprising at least a first block which is hydrophobic in nature; and

B is a monoblock, diblock or triblock polymer comprising at least one monomer of vinyl acetate.

In another aspect, described herein are aqueous compositions comprising:

water;

optionally, a pigment; and

a film-forming latex composition with modified surface chemistry obtained by free-radical emulsion polymerization in the presence:

of at least one ethylenically unsaturated monomer or at least one polymer containing residual ethylenically unsaturated bonds,

of at least one free-radical polymerization initiator, and

of at least one water-soluble and/or water-dispersible polymer comprising formula (I):

(R¹¹)x-Z¹¹—C(═S)—Z¹²-[A]-R¹² (I)

wherein:

Z¹¹ represents C, N, O, S or P,

Z¹² represents S or P,

R¹¹ and R¹², which may be identical or different, represent:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii),

these groups (1) rings (i) or heterocycles (iii) being optionally substituted with substituted phenyl groups, substituted aromatic groups or groups selected from:
alkoxycarbonyl or aryloxycarbonyl (—COOR) groups,
carboxyl (—COOH) groups,
acyloxy (—O₂CR) groups,
carbamoyl (—CONR₂) groups,
cyano (—CN) groups,
alkylcarbonyl groups,
alkylarylcarbonyl groups,
arylcarbonyl groups,
arylalkylcarbonyl groups,
phthalimido groups,
maleimido groups,
succinimido groups,
amidine groups,
guanidimo groups,
hydroxyl (—OH) groups,
amino (—NR₂) groups,
halogen groups,
allyl groups,
epoxy groups,
alkoxy (—OR) groups,
S-alkyl groups,
S-aryl groups,
alkali metal salts of carboxylic acids,
alkali metal salts of sulphonic acid,
polyalkylene oxide (PEO or PPO) chains, and
quaternary ammonium salts,
   wherein R represents an alkyl or aryl group,

x corresponds to the valency of Z¹¹, or alternatively x is 0, in which case Z¹¹ represents a phenyl, alkene or alkyne radical, being optionally substituted with groups selected from:

an optionally substituted alkyl, acyl, aryl, alkene or alkyne group, an optionally substituted, saturated, unsaturated, or aromatic, carbon-based ring, an optionally substituted, saturated or unsaturated heterocycle; an alkoxycarbonyl or aryloxycarbonyl (—COOR) group,
a carboxyl (COOH) group,
an acyloxy (—O₂CR) group,
a carbamoyl (—CONR₂) group,
a cyano (—CN) group;
an alkylcarbonyl group;
an alkylarylcarbonyl group;
an arylcarbonyl group;
an arylalkylcarbonyl group;
a phthalimido group,
a maleimido group,
a succinimido group,
a amidino group,
a guanidimo group,
a hydroxyl (—OH) group,
an amino (—NR₂) group,
a halogen group,
an allyl group,
an epoxy group,
an alkoxy (—OR) croup,
a 3-alkyl group,
a S-aryl group,
an alkali metal salt of carboxylic acid,
an alkali metal salt of sulphonic acid,
polyalkylene oxide (PEO or PPO) chains, and
quaternary ammonium salts,
   wherein R represents an alkyl or aryl group; and

A represents a monoblock, diblock or triblock polymer comprising at least a first block which is hydrophilic in nature and a second block which is hydrophobic in nature.

In one embodiment, the latex composition is obtained by free-radical emulsion polymerization in the absence of a surfactant. In another embodiment, the water-soluble and/or water-dispersible polymer of formula (I), formula (Ia) or formula (Ib) has a weight average molecular weight of from 5,000 to 7,000 Daltons. In another embodiment, the water-soluble and/or water-dispersible polymer of formula (I), formula (Ia) or formula (Ib) has a weight average molecular weight of from 1,000 to 20,000 Daltons. In another embodiment, the water-soluble and/or water-dispersible polymer of formula (I), formula (Ia) or formula (Ib) has a weight average molecular weight of from 1,000 to 10,000 Daltons.

In another embodiment, the at least one ethylenically unsaturated monomer comprises:

(a) at least one first monomer selected from: methyl (meth)acrylate, ethyl (meth)acrylate, butyl (meth)acrylate, isobutyl (meth)acrylate, cyclohexyl (meth)acrylate, 2-ethylhexyl (meth)acrylate, isodecyl (meth)acrylate, lauryl (meth)acrylate isobornyl (meth)acrylate, benzyl (meth)acrylate, hydroxyethyl (meth)acrylate, hydroxypropyl (meth)acrylate, methoxyethyl (meth)acrylate, ethoxyethyl (meth)acrylate, phenoxyethyl (meth)acrylate, tetrahydrofurfuryl (meth)acrylate, glycidyl (meth)acrylate, dimethylaminoethyl (meth)acrylate, diethylaminoethyl (meth)acrylate, tert-butylaminoethyl (meth)acrylate, and acetoxyethyl (meth)acrylate, (meth)acrylamides such as, (meth)acrylamide, N-methylol (meth)acrylamide, N-butoxyethyl (meth)acrylamide, N,N-dimethyl (meth)acrylamide, N-isopropyl (meth)acrylamide, N-tert-butyl (meth)acrylamide, N-tert-octyl (meth)acrylamide, diacetone (meth)acrylamide, vinyl propionate, vinyl 2-ethylhexanoate, N-vinylamides such as: N-vinylpyrrolidione, N-vinylcaprolactam, N-vinylformamide, and N-vinylacetamide, methyl vinyl ether, 2-phosphate ethylene methacrylate, 2-sulphoethylene methacrylate, ethyl vinyl ether, butyl vinyl ether, hydroxybutyl vinyl ether, and styrene; and

(b) at least one second monomer selected from: acrylic acid, methacrylic acid, itaconic acid, maleic acid, fumaric acid, butyl methyl maleate, vinyl sulfonic acid 2-acrylamido-2-methylpropane sulfonic acid, styrene sulfonic acid, vinyl phosphonic acid, vinylbenzenesulphonic acid, α-acrylamidomethyl propanesulphonic acid, allyl phosphonic acid, and salts of any thereof.

In another embodiment, the at least one ethylenically unsaturated monomer comprises:

(a) a first monomer selected from vinyl acetate; and

(b) at least one second monomer selected from: acrylic acid, methacrylic acid, maleic acid, fumaric acid, butyl methyl maleate, vinyl sulfonic acid, 2-acrylamido-2-methylpropane sulfonic acid, styrene sulfonic acid, vinyl phosphonic acid, vinylbenzenesulphonic acid, α-acrylamidomethyl propanesulphonic acid, allyl phosphonic acid, and salts of any thereof.

Also described herein are processes for preparing an aqueous polymer dispersion, which in one embodiment, the process comprises the step of contacting the compound of any of formula (I), formula (Ia) or formula (Ib) in an aqueous polymerization medium with at least one ethylenically unsaturated monomers and at least one free radical initiator; thereby allowing free-radical polymerization of the ethylenically unsaturated monomers.

These and other features and advantages of the present invention will become more readily apparent to those skilled in the art upon consideration of the following detailed description, which describe both the preferred and alternative embodiments of the present invention.

### DETAILED DESCRIPTION OF INVENTION

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted with one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cr-Cs)” in reference to an organic group, wherein r and s are each integers, indicates that the group may contain from r carbon atoms to s carbon atoms per group.

As used herein, the term “degree of substitution” as employed herein is the average substitution of functional groups per anhydro sugar unit in the polygalactomannan gum. In guar gum, the basic unit of the polymer consists of two mannose units with a glycosidic linkage and a galactose unit attached to the C₆ hydroxyl group of one of the mannose units. On the average, each of the anhydro sugar units contains three available hydroxyl sites. A degree of substitution of 3 would mean that all of the available hydroxyl sites have been esterified with functional groups.

As used herein the term “(meth)acrylate” refers collectively and alternatively to the acrylate and methacrylate and the term “(meth)acrylamide” refers collectively and alternatively to the acrylamide and methacrylamide, so that, for example, “butyl (meth)acrylate” means butyl acrylate and/or butyl methacrylate.

As used herein, “molecular weight” in reference to a polymer or any portion thereof, means to the weight-average molecular weight (“Mw”) of the polymer or portion. Mw of a polymer is a value measured by gel permeation chromatography (GPC) with an aqueous eluent or an organic eluent (for example dimethylacetamide, dimethylformamide, and the like), depending on the composition of the polymer, light scattering (DLS or alternatively MALLS), viscometry, or a number of other standard techniques. Mw of a portion of a polymer is a value calculated according to known techniques from the amounts of monomers, polymers, initiators and/or transfer agents used to make the portion.

In one embodiment, the copolymers for use in the present invention exhibit a weight average molecular weight, as determined by gel permeation chromatography (GPC) and light scattering of a solution of the polymer in tetrahydrofuran and compared to a polystyrene standard, of greater than or equal to 30,000 grams per mole (“g/mole”). HASE thickeners may not fully dissolve in THF but after hydrolysis they can dissolve in water and measurement can be run in a water gel permeation chromatography (GPC). Reference: Macromolecules 2000, 33, 2480. For example in a range of 30,000 to 2,000,000 g/mole.

As used herein, each of the terms “monomer”, “polymer”, “homopolymer”, “copolymer”, “linear polymer”, “branched polymer”, “star polymer”, “comb polymer”, “random copolymer”, alternating copolymer”, “block copolymer”, “graft copolymer”, has the meaning ascribed to it in Glossary of basic terms in polymer science (IUPAC Recommendations 1996), Pure Appl. Chem., Vol. 68, No. 12, pp. 2287-2311, 1996.

As used herein, the indication that a radical may be “optionally substituted” or “optionally further substituted” means, in general, unless further limited, either explicitly or by the context of such reference, such radical may be substituted with one or more inorganic or organic substituent groups, for example, alkyl, alkenyl, aryl, arylalkyl, alkaryl, a hetero atom, or heterocyclyl, or with one or more functional groups capable of coordinating to metal ions, such as hydroxyl, carbonyl, carboxyl, amino, imino, amido, phosphonic acid, sulphonic acid, or arsenate, or inorganic and organic esters thereof, such as, for example, sulphate or phosphate, or salts thereof.

As used herein, the term “water-soluble copolymer” means a copolymer which, when it is brought into contact with water, spontaneously forms a solution which tends to homogenize. If the mixture is left for several days with gentle agitation, any sample taken from any place in the volume occupied by the sample gives the same concentration value as the mean concentration value. Included in this definition are not only completely soluble copolymers, but also copolymers which form a homogeneous solution having a slight turbidity due to local aggregation of the copolymer.

As used herein, the term “amphiphilic copolymer” means a copolymer obtained by polymerization of hydrophilic monomers and hydrophobic monomers; this copolymer comprises hydrophobic segments and hydrophilic segments and, as a result, exhibits different regions of solubility in water.

As used herein, “parts by weight” or “pbw” in reference to a named compound refers to the amount of the named compound, exclusive, for example, of any associated solvent. In some instances, the trade name of the commercial source of the compound is also given, typically in parentheses. For example, a reference to “10 pbw cocoamidopropylbetaine (“CAPB”, as MIRATAINE BET C-30)” means 10 pbw of the actual betaine compound, added in the form of a commercially available aqueous solution of the betaine compound having the trade name “MIRATAINE BET C-30”, and exclusive of the water contained in the aqueous solution.

As used herein, an indication that a composition is “substantially free” of a specific material, means the composition contains no more than an insubstantial amount of that material, and an “insubstantial amount” means an amount that does not measurably affect the desired properties of the composition.

As used herein, the term “surfactant” means a compound that reduces surface tension when dissolved in water.

As used herein, suitable polymerizable functional groups include, for example, acrylo, methacrylo, acrylamido, methacrylamido, diallylamino, allyl ether, vinyl ether, α-alkenyl, maleimido, styrenyl, and α-alkyl styrenyl groups.

Latex (emulsion polymers) are used commonly and widely in paints and coatings, adhesives, sealants and elastomeric applications. Typical preparation for the industrial production of latex polymers involves the use of monomers from styrene, butyl acrylate, and ethyl hexyl acrylate to vinyl acetate to gaseous monomers such as ethylene, plus typical initiators such as ammonium persulfate etc. and surfactants to stabilize the latex particles ranging from 40 to 500 nm (typically 80-250 nm).

The amount of surfactant used to make the latex can range between 1-3% based on the total amount of monomers. Surfactants are used to not only control the particle size but also to provide shear stability and therefore play a crucial in preparation of latexes and long term shelf stability of the latex.

The advantages of using surfactants of different types for the above benefits are then outweighed by the need to minimize the surfactant levels to obtain films of latex that can give excellent water resistance together with adhesion to substrates. The importance of reducing surfactants therefore becomes critical and more critical in paint films (with low or high PVC) as the presence of surfactants tends to diminish the aesthetic appearance of the paint film (blistering, leaching, craters etc.).

To improve the water resistance of latex films and that of paint films in particular especially for latex polymers based on co-polymers of vinyl acetate, or co-polymers of styrene acrylates, the usage of surfactant has been minimized or attempts have been made using polymerizable surfactants. In both cases results have not been satisfactory in obtaining good water resistance or other performance properties.

In one embodiment, the use of hydrophilic precursors with a xanthate moiety (otherwise, herein referred to as “Macro CTA”) in emulsion polymerization of at least one monomer have been prepared to yield stable latexes with particle size ranging from 80-200 nm. In one embodiment, the films of the polymers prepared using Macro CTA show surprisingly good water resistance as measured through a variety of test methods for water resistance namely the water droplet, water immersion and water vapor. In another embodiment, the use of hydrophilic precursors with a xanthate moiety in emulsion polymerization of a vinyl acetate monomer with other co-monomers yielded stable latexes with particle size ranging from 80-200 nm and the films of the polymers are showing surprisingly exceptional water resistance as measured through a variety of test methods for water resistance namely the water droplet, water immersion and water vapor.

In one embodiment, use of hydrophilic precursors with a xanthate moiety in emulsion polymerization of a styrene monomer with other co-monomers yielded stable latexes. in particular vinyl acetate with other co-monomers and also of styrene with other co-monomers The films of the above prepared latex with Macro CTA for example were tested by the water immersion test by soaking the film of the latex in water for up to 8 days and monitoring for blushing (whiteness) or any other film defects, and by the water vapor method for an hour against film of commercial latexes and latexes produced using standard surfactants.

In one embodiment, films of latex based on commercial latex and those with surfactants prepared in the laboratory blush (the degree of whiteness) after 24 hours and the blush of the film becomes progressively deeper over time, while the film of latex based on co-polymers of vinyl acetate or styrene acrylic show no tendency toward whiteness even after 8 days of allowing the films to soak in water.

Latexes prepared using Macro CTA and based on co-polymers of vinyl acetate and of co-monomer of styrene (as compared to latexes based on surfactants) have shown enhanced shear stability, freeze thaw and electrolyte stability and films of the latex show enhanced adhesion to metallic substrate.

In some embodiments, the latex prepared using Macro CTA (containing Xanthate moiety) can easily be scaled for commercial purposes. The preparation of the seed of above latex polymers (vinyl acetate co-polymers and or of styrene copolymers), which is part of the preparation in making latexes of high solids are also claimed as key finding of this disclosure.

Macro CTA can also be utilized with the use of specialty monomers that are available will allow for tailoring of latexes for various performances and multifunctional performance and thereby extending the application beyond just paints and coating applications, which include but are not limited to coatings, adhesives, sealants, elastomeric applications, and the like.

The latex of the present invention comprises, in dispersion, a water-insoluble polymer obtained from monomers comprising ethylenic unsaturation. The monomers as mentioned herein can be used as ethylenically unsaturated monomers involved in the production of the latex. Latexes with modified surface properties, which can be obtained using a method which comprises addition of a water-soluble amphiphilic copolymer to an aqueous dispersion of a water-insoluble polymer or copolymer obtained from monomers with ethylenic unsaturation.

In one embodiment, the latexes can be used as binding agents in various applications in the fields of paint, papermaking coating, coatings and construction materials.

In one embodiment, a non-surfactant copolymer can be obtained through the choice of monomers, including but not limited to, for example, a Styrene/BA copolymer is non-surfactant. It is also possible to obtain a non-surfactant block copolymer by increasing the molecular mass or by decreasing the fraction of hydrophobic monomers in the copolymer.

In general, the water-soluble amphiphilic block copolymers described above can be obtained by any polymerization process referred to as “living” or “controlled”, such as, for example:

free-radical polymerization controlled by xanthates, according to the teaching of application WO 98/58974,

free-radical polymerization controlled by dithioesters, according to the teaching of application WO 97/01478,

polymerization using nitroxide precursors, according to the teaching of application WO 99/03894,

free-radical polymerization controlled by dithiocarbamates, according to the teaching of application WO 99/31144, and/or

atom transfer free-radical polymerization (ATRP), according to the teaching of application WO 96/30421.

Macro CTA

A monoblock, diblock or triblock polymer corresponds to the following formula (I):

(R¹¹)x-Z¹¹—C(═S)—Z¹²-[A]-R¹² (I)

in which formula:

Z¹¹ represents C, N, O, S or P,

Z¹² represents S or P,

R¹¹ and R¹², which may be identical or different, represent:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii), these groups and rings (i), (ii) and (iii) possibly being substituted with substituted phenyl groups, substituted aromatic groups or groups: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
R representing an alkyl or aryl group,

x corresponds to the valency of Z¹¹, or alternatively

x is 0, in which case Z¹¹ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR), carbamoyl (—CONR₂); cyano (—CN); alkylcarbonyl, alkylarylcarbonyl; arylcarbonyl; arylalkylcarbonyl; phthalimido; maleimido; succinimido; amidino; guanidimo; hydroxyl (—OH); amino (—NR₂); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts);

-[A]- represents a monoblock, diblock or triblock polymer.

According to one advantageous variant of the invention, the compound of formula (I), formula (Ia) or formula (Ib) is such that Z¹¹ is an oxygen atom and Z¹² is a sulphur atom. These compounds are thus functionalized at the end of the chain with xanthates.

In one embodiment, -[A]- corresponds more particularly to at least one of the three formulae below:

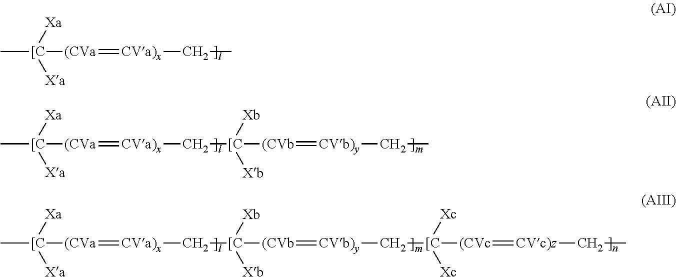

in which formulae:
Va, V′a, Vb, V′b, Vc and V′c, which may be identical or different, represent: H, an alkyl group or a halogen,
Xa, X′a, Xb, X′b, Xc and X′c, which may be identical or different, represent H, a halogen or a group R, OR, OCOR, NHCOH, OH, NH2, NHR, N(R)₂, (R)₂N⁺O⁻, NHCOR, CO₂H, CO₂R, CN, CONH₂, CONHR or CONR₂, in which R, which may be identical or different, are chosen from alkyl, aryl, aralkyl, alkaryl, alkene and organosilyl groups, optionally perfluorinated and optionally substituted with one or more carboxyl, epoxy, hydroxyl, alkoxy, amino, halogen or sulphonic groups,
l, m and n, which may be identical or different, are greater than or equal to 1
x, y and z, which may be identical or different, are equal to 0 or 1.

More particularly, [A] is obtained by using at least one ethylenically unsaturated monomer chosen from hydrophilic monomers.

Examples of such monomers that may especially be mentioned include
ethylenically unsaturated monocarboxylic and dicarboxylic acids, for instance acrylic acid, methacrylic acid, itaconic acid, maleic acid or fumaric acid,
monoalkyl esters of dicarboxylic acids of the type mentioned with alkanols preferably containing 1 to 4 carbon atoms, and N-substituted derivatives thereof, such as, 2-hydroxyethyl acrylate or methacrylate,
unsaturated carboxylic acid amides, for instance acrylamide or methacrylamide,
ethylenic monomers comprising a sulphonic acid group and ammonium or alkali metal salts thereof, for example vinylsulphonic acid, vinylbenzenesulphonic acid, α-acrylamidomethyl propanesulphonic acid or 2-sulphoethylene methacrylate.

It is possible to incorporate into the polymer composition a proportion of hydrophobic monomers, provided that the solubility/dispersity conditions and the conditions of non-formation of gelled or non-gelled micelles, mentioned previously, remain valid.

Illustrations of hydrophobic monomers that may especially be mentioned include styrene or its derivatives, butadiene, chloroprene, (meth)acrylic esters, vinyl esters and vinyl nitriles.

The term “(meth)acrylic esters” denotes esters of acrylic acid and of methacrylic acid with hydrogenated or fluorinated C₁-C₁₂ and preferably C₁-C₈ alcohols. Among the compounds of this type that may be mentioned are: methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate.

The vinyl nitriles more particularly include those containing from 3 to 12 carbon atoms, such as, in particular, acrylonitrile and methacrylonitrile.

It should be noted that the styrene may be totally or partially replaced with derivatives such as α-methylstyrene or vinyltoluene.

The other ethylenically unsaturated monomers that may be used, alone or as mixtures, or that are copolymerizable with the above monomers are especially:
vinyl esters of a carboxylic acid, for instance vinyl acetate, vinyl versatate or vinyl propionate,
vinyl halides,
vinylamine amides, especially vinylformamide or vinylacetamide,
ethylenically unsaturated monomers comprising a secondary, tertiary or quaternary amino group, or a heterocyclic group containing nitrogen, such as, for example, vinylpyridines, vinylimidazole, aminoalkyl (meth)acrylates and aminoalkyl(meth)acrylamides, for instance dimethylaminoethyl acrylate or methacrylate, di-tert-butylaminoethyl acrylate or methacrylate, dimethylaminomethylacrylamide or dimethylaminomethylmethacrylamide, or ethylene ureido functionality attached to derivatives of ethylene oxide or propylene oxide of allyl glycidal ether or methacrylate derivatives such as N(2-methacryloyloxyethyl)ethylene urea. It is likewise possible to use zwitterionic monomers such as, for example, sulphopropyl (dimethyl)aminopropyl acrylate,
ethylenic monomers comprising a phosphate acid group and ammonium or alkali metal salts thereof, for example vinylphosphonic acid or 2-phosphate ethylene methacrylate.

According to one particularly advantageous embodiment, the polymer A is a monoblock or a diblock polymer.

In one embodiment, polymer A has a number-average molar mass of less than 1000 and preferably less than 20000. In another embodiment, polymer A has a weight average molecular weight of less than 1000 and preferably less than 20000. These molar masses are measured by steric exclusion chromatography, using polyethylene glycol as standard.

According to a second embodiment of the invention, the monoblock, diblock or triblock polymer used is a polymer corresponding to the following formulae:

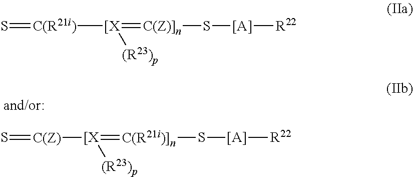

in which formulae:
X represents an atom chosen from N, C, P and Si,
R²² represents:
   an optionally substituted alkyl, acyl, aryl, alkene or alkyne group (i), or
   a saturated or unsaturated, optionally substituted or aromatic carbon-based ring (ii), or
   a saturated or unsaturated, optionally
   substituted or aromatic heterocycle (iii), these groups and rings (i), (ii) and (iii) possibly being substituted with substituted phenyl groups, substituted aromatic groups or groups:
   alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, organosilyl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
R representing an alkyl or aryl group,
Z, R²¹ⁱ and R²³, which may be identical or different, are chosen from:
   a hydrogen atom,
   an optionally substituted alkyl, acyl, aryl, alkene or alkyne group,
   a saturated or unsaturated, optionally substituted or aromatic carbon-based ring,
   a saturated or unsaturated, optionally substituted heterocycle,
   alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimide, amidino, guanidimo, hydroxyl (—OH), amino (—NR2), halogen, allyl, epoxy, alkoxy (—OR), S-alkyl, S-aryl and organosilyl groups, R representing an alkyl or aryl group,
   groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
n>0,
i ranges from 1 to n,
p is equal to 0, 1 or 2 depending on the valency of X, and also
if X=C, then Z is not an S-alkyl or S-aryl group,
the group R¹¹, where i=n, is not an S-alkyl or S-aryl group,
A represents a monoblock, diblock or triblock polymer as defined herein.

In order to obtain water-soluble amphiphilic copolymers comprising hydrophilic and hydrophobic blocks, this process consists in forming a first block according to the following steps:

(1) bringing into contact:
at least one ethylenically unsaturated monomer,
at least one source of free radicals, and
at least one compound of formula (I), formula (Ia) or formula (Ib) as described herein;

(2) forming a second block by repeating step 1 using: monomers which are different in nature, and in place of the precursor compound of formula (I), formula (Ia) or formula (Ib), the polymer derived from step 1; and

(3) Optionally hydrolyzing, at least partially, the copolymer obtained.

During step 1, a first block of the polymer is synthesized which is mainly hydrophilic or hydrophobic in nature depending on the nature and the amount of the monomers used. During step 2, the other block of the polymer is synthesized.

The ethylenically unsaturated monomers will be chosen from the hydrophilic, hydrophobic and hydrolyzable monomers defined herein, in proportions suitable for obtaining a block copolymer in which the blocks exhibit the characteristics defined above.

According to this process, if all the successive polymerizations are carried out in the same reactor, it is generally preferable for all the monomers used in a step to be consumed before the polymerization of the subsequent step begins, therefore before the new monomers are introduced. However, it may so happen that the hydrophobic or hydrophilic monomers of the preceding step are still present in the reactor during the polymerization of the subsequent block. In this case, these monomers generally represent no more than 5 mol % of all the monomers and they participate in the polymerization by contributing to the introduction of the hydrophobic or hydrophilic units into the subsequent block.

A water-soluble amphiphilic copolymer comprising blocks which are hydrophilic in nature and which are hydrophobic in nature can be obtained from a single type of hydrophobic hydrolyzable monomer. In this case, step 2 is no longer necessary, but partial hydrolysis of the polymer is then essential.

Using the same process, it is possible to obtain a copolymer comprising n blocks by repeating the preceding steps 1 and 2, but replacing the compound of formula (I), formula (Ia) or formula (Ib) with the copolymer comprising n−1 blocks.

In one embodiment, the copolymers obtained by the processes described above generally exhibit a polydispersity index of at most 2, typically of at most 1.5. It may be desired to mix with the latex blocks whose polydispersity is controlled. In this case, it is possible to mix, in precise proportions, several water-soluble amphiphilic copolymers comprising a block which is hydrophilic in nature and a block which is hydrophobic in nature, each having a clearly defined molecular mass.

In one embodiment, described herein are methods of preparing an aqueous coating composition by mixing together at least one latex polymer derived from at least one monomer and at least one pigment. Preferably, the latex polymer is in the form of latex polymer dispersion. The additives discussed above can be added in any suitable order to the latex polymer, the pigment, or combinations thereof, to provide these additives in the aqueous coating composition. In the case of paint formulations, the aqueous coating composition preferably has a pH of from 7 to 10.

In formulating latexes and latex paints/coatings, physical properties that may be considered include, but are not limited to, viscosity versus shear rate, ease of application to surface, spreadability, and shear thinning.

When hydrolyzable hydrophobic monomers are used, the hydrolysis may be carried out using a base or an acid. The base can be chosen from alkali metal or alkaline earth metal hydroxides, such as sodium hydroxide or potassium hydroxide, alkali metal alkoxides, such as sodium methoxide, sodium ethoxide, potassium methoxide, potassium ethoxide or potassium t-butoxide, ammonia and amines, such as triethylamines. The acids can be chosen from sulfuric acid, hydrochloric acid and para-toluenesulfonic acid. Use may also be made of an ion-exchange resin or an ion-exchange membrane of the cationic or anionic type. The hydrolysis is generally carried out at a temperature of between 5 and 100° C., preferably between 15 and 90° C. Preferably, after hydrolysis, the block copolymer is washed, for example by dialysis against water or using a solvent such as alcohol. It may also be precipitated by lowering the pH below 4.5.

The hydrolysis may be carried out on a single-block polymer, which will subsequently be associated with other blocks, or on the final block polymer.

The latex of the present invention comprises, in dispersion, a water-insoluble polymer obtained from monomers comprising ethylenic unsaturation. All the monomers which had been mentioned in the context of the definition of the water-soluble amphiphilic copolymer can be used as monomers comprising ethylenic unsaturations involved in the production of the latex. Reference may therefore be made to this part of the description for choosing a useful monomer comprising ethylenic unsaturation.

The monomers typically employed in emulsion polymerization to make latex for latex paint include, but are not limited to such monomers as methyl acrylate, ethyl acrylate, methyl methacrylate, butyl acrylate, 2-ethyl hexyl acrylate, other acrylates, methacrylates and their blends, acrylic acid, methacrylic acid, styrene, vinyl toluene, vinyl acetate, vinyl esters of higher carboxylic acids than acetic acid, e.g. vinyl versatate, acrylonitrile, acrylamide, butadiene, ethylene, vinyl chloride and the like, and mixtures thereof. This is further discussed below in the section entitled “Latex Monomers”.

The latex monomers fed to a reactor to prepare the polymer latex binder preferably include at least one acrylic monomer selected from the group consisting of acrylic acid, acrylic acid esters, methacrylic acid, and methacrylic acid esters. In addition, the monomers can include styrene, vinyl acetate, or ethylene. The monomers can also include one or more monomers selected from the group consisting of styrene, (alpha)-methyl styrene, vinyl chloride, acrylonitrile, methacrylonitrile, ureido methacrylate, vinyl acetate, vinyl esters of branched tertiary monocarboxylic acids (e.g. vinyl esters commercially available under the mark VEOVA from Shell Chemical Company or sold as EXXAR neo vinyl esters by ExxonMobil Chemical Company), itaconic acid, crotonic acid, maleic acid, fumaric acid, and ethylene. It is also possible to include C4-C8 conjugated dienes such as 1,3-butadiene, isoprene or chloroprene. Commonly used monomers in making acrylic paints are butyl acrylate, methyl methacrylate, ethyl acrylate and the like. Preferably, the monomers include one or more monomers selected from the group consisting of n-butyl acrylate, methyl methacrylate, styrene and 2-ethylhexyl acrylate.

The latex polymer is typically selected from the group consisting of pure acrylics (comprising acrylic acid, methacrylic acid, an acrylate ester, and/or a methacrylate ester as the main monomers); styrene acrylics (comprising styrene and acrylic acid, methacrylic acid, an acrylate ester, and/or a methacrylate ester as the main monomers); vinyl acrylics (comprising vinyl acetate and acrylic acid, methacrylic acid, an acrylate ester, and/or a methacrylate ester as the main monomers); and acrylated ethylene vinyl acetate copolymers (comprising ethylene, vinyl acetate and acrylic acid, methacrylic acid, an acrylate ester, and/or a methacrylate ester as the main monomers). The monomers can also include other main monomers such as acrylamide and acrylonitrile, and one or more functional monomers such as itaconic acid and ureido methacrylate, as would be readily understood by hose skilled in the art. In a particularly preferred embodiment, the latex polymer is a pure acrylic such as a butyl acrylate/methyl methacrylate copolymer derived from monomers including butyl acrylate and methyl methacrylate.

In typical acrylic paint compositions the polymer is comprised of one or more esters of acrylic or methacrylic acid, typically a mixture, e.g. about 50/50 by weight, of a high Tg monomer (e.g. methyl methacrylate) and a low Tg monomer (e.g. butyl acrylate), with small proportions, e.g. about 0.5% to about 2% by weight, of acrylic or methacrylic acid. The vinyl-acrylic paints usually include vinyl acetate and butyl acrylate and/or 2-ethyl hexyl acrylate and/or vinyl versatate. In vinyl-acrylic paint compositions, at least 50% of the polymer formed is comprised of vinyl acetate, with the remainder being selected from the esters of acrylic or methacrylic acid. The styrene/acrylic polymers are typically similar to the acrylic polymers, with styrene substituted for all or a portion of the methacrylate monomer thereof.

The latex polymer dispersion preferably includes from about 30 to about 75% solids and a mean latex particle size of from about 70 to about 650 nm. The latex polymer is preferably present in the aqueous coating composition in an amount from about 5 to about 60 percent by weight, and more preferably from about 8 to about 40 percent by weight (i.e. the weight percentage of the dry latex polymer based on the total weight of the coating composition).

The aqueous coating composition is a stable fluid that can be applied to a wide variety of materials such as, for example, paper, wood, concrete, metal, glass, ceramics, plastics, plaster, and roofing substrates such as asphaltic coatings, roofing felts, foamed polyurethane insulation; or to previously painted, primed, undercoated, worn, or weathered substrates. The aqueous coating composition of the invention can be applied to the materials by a variety of techniques well known in the art such as, for example, brush, rollers, mops, air-assisted or airless spray, electrostatic spray, and the like.

Latex paint formulations typically comprise additives, e.g., at least one pigment. In a preferred embodiment of the invention the latex paint formulation includes at least one pigment selected from the group consisting of TiO2, CaCO3, clay, aluminum oxide, silicon dioxide, magnesium oxide, sodium oxide, potassium oxide, talc, barytes, zinc oxide, zinc sulfite and mixtures thereof. More preferably the at least one pigment includes TiO2, calcium carbonate or clay.

In addition to the above components, the aqueous coating composition can include one or more additives selected from the group consisting of dispersants, surfactants, rheology modifiers, defoamers, thickeners, biocides, mildewcides, colorants, waxes, perfumes and co-solvents.

In one embodiment, the composition of the present invention (for example paints or stains) comprises the selected polymer and a liquid carrier.

In one embodiment, the liquid carrier is an aqueous carrier comprising water and the treatment solution is in the form of a solution, emulsion, or dispersion of the material and additives. In one embodiment, the liquid carrier comprises water and a water miscible organic liquid. Suitable water miscible organic liquids include saturated or unsaturated monohydric alcohols and polyhydric alcohols, such as, for example, methanol, ethanol, isopropanol, cetyl alcohol, benzyl alcohol, oleyl alcohol, 2-butoxyethanol, and ethylene glycol, as well as alkylether diols, such as, for example, ethylene glycol monoethyl ether, propylene glycol monoethyl ether and diethylene glycol monomethyl ether.

As used herein, terms “aqueous medium” and “aqueous media” are used herein to refer to any liquid medium of which water is a major component. Thus, the term includes water per se as well as aqueous solutions and dispersions.

Monomers:

The monomers can be copolymerized in such proportions, and the resulting emulsion polymers can be physically blended, to give products with the desired balance of properties for specific applications. For example, for analogous polymers of a given molecular weight, increasing the amount of first monomer tends to increase the yield strength exhibited by the polymer, increasing the relative amount of second monomer tends to increase the viscosity of the polymer. One or more fourth monomers may be added to adjust the properties of the polymer.

Ethylenically Unsaturated Monomers

In one embodiment, the reactive group of the additional associative monomer is an ethylenically unsaturated group and the monomer is an ethylenically unsaturated monomer comprising at least one site of ethylenic unsaturation, more typically, an α-, β-unsaturated carbonyl moiety, and at least one group according to structure (D.XXI) per molecule and copolymerizable with the acidic monomer and the non-ionic monomer.

In one embodiment, the optional additional associative monomer comprises one or more compounds according to structure (D.XXIII):

R²⁴—R²³—R²²—R²¹ (D.XXIII)

wherein:

R²¹, R²², and R²³ are each as described above, and

R²⁴ is a moiety having a site of ethylenic unsaturation. Thus the resulting hydrophobic monomeric unit has the structure (D.XXIV):

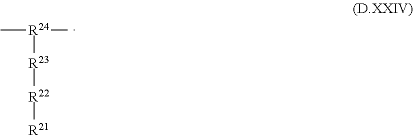

In one embodiment, the compound according to structure (D.XXI) is an α-, β-unsaturated carbonyl compound. In one embodiment, R²³ is according to structure (D.X).

In one embodiment, the additional associative monomer comprises one or more compounds according to structure (D.XXV):

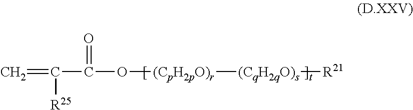

wherein

R²¹ is linear or branched (C₅-C₅₀)alkyl, hydroxyalkyl, alkoxyalkyl, aryl, or arylalkyl,
R²⁵ is methyl or ethyl, and
p and q are independently integers of from 2 to 5, more typically 2 or 3,
each r is independently an integer of from 1 to about 80, more typically from 1 to about 50,
each s is independently an integer of from 0 to about 80, more typically from 0 to about 50,
t is an integer of from 1 to about 50, provided that the product obtained by multiplying the integer t times the sum of r+s is from 2 to about 100; or p, q, r, s, and t are each as otherwise described above.

In one embodiment, the additional associative monomer comprises one or more compounds according to structure (D.XXV) wherein R²¹ is linear (C₁₆-C₂₂)alkyl.

In one embodiment, the optional additional associative monomer comprises one or more compounds according to structure (D.XXV) wherein R²¹ is a branched (C₅-C₅₀)alkyl group, more typically a branched (C₅-C₅₀)alkyl group according to structure (D.VIII). For example R²¹ may have the structure D.XXVI

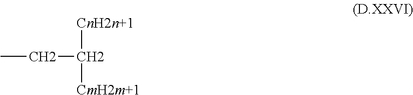

wherein m and n each, independently, are positive integers from 1 to 39 and m+n represents an integer from 4 to 40, as disclosed by US Patent Application Publication 2006/02700563 A1 to Yang et al, incorporated herein by reference.

In one embodiment, the optional additional associative monomer comprises one or more compounds according to structure (D.XXV) wherein p=2, s=0, and t=1.

In one embodiment, the optional additional associative monomer comprises one or more compounds according to structure (D.XXV) wherein R²¹ is linear (C₁₆-C₂₂)alkyl, R²⁵ is methyl or ethyl, p=2, s=0, and t=1.

Suitable ethylenically unsaturated optional additional associative monomers include:

alkyl-polyether (meth)acrylates that comprise at least one linear or branched (C₅-C₄₀)alkyl-polyether group per molecule, such as hexyl polyalkoxylated (meth)acrylates, tridecyl polyalkoxylated (meth)acrylates, myristyl polyalkoxylated (meth)acrylates, cetyl polyalkoxylated (meth)acrylates, stearyl polyalkoxylated (methyl)acrylates, eicosyl polyalkoxylated (meth)acrylates, behenyl polyalkoxylated (meth)acrylates, melissyl polyalkoxylated (meth)acrylates, tristyrylphenoxyl polyalkoxylated (meth)acrylates, and mixtures thereof,

alkyl-polyether (meth)acrylamides that comprise at least one (C₅-C₄₀)alkyl-polyether substituent group per molecule, such as hexyl polyalkoxylated (meth)acrylamides, tridecyl polyalkoxylated (meth) acrylamides, myristyl polyalkoxylated (meth) acrylamides, cetyl polyalkoxylated (meth)acrylamides, stearyl polyalkoxylated (methyl) acrylamides, eicosyl polyalkoxylated (meth) acrylamides, behenyl polyalkoxylated (meth) acrylamides, melissyl polyalkoxylated (meth) acrylamides and mixtures thereof,

alkyl-polyether vinyl esters, alkyl-polyether vinyl ethers, or alkyl-polyether vinyl amides that comprise at least one (C₅-C₄₀)alkyl-polyether substituent group per molecule such as vinyl stearate polyalkoxylate, myristyl polyalkoxylated vinyl ether, and mixtures thereof,

as well as mixtures of any of the above alkyl-polyether acrylates, alkyl-polyether methacrylates, alkyl-polyether acrylamides, alkyl-polyether methacrylamides, alkyl-polyether vinyl esters, alkyl-polyether vinyl ethers, and/or alkyl-polyether vinyl amides.

In one embodiment, the optional additional associative monomer comprises one or more alkyl-polyalkoxylated (meth)acrylates that comprise one linear or branched (C₅-C₄₀)alkyl-polyethoxylated group, more typically (C₁₀-C₂₂)alkyl-polyethoxylated group per molecule, such as decyl-polyethoxylated (meth)acrylates, tridecyl-polyethoxylated (meth)acrylates, myristyl-polyethoxylated (meth)acrylates, cetyl-polyethoxylated (meth)acrylates, stearyl-polyethoxylated (methyl)acrylates, eicosyl-polyethoxylated (meth)acrylates, behenyl-polyethoxylated (meth)acrylates, even more typically decyl-polyethoxylated methacrylates, tridecyl-polyethoxylated methacrylates, myristyl-polyethoxylated methacrylates, cetyl-polyethoxylated methacrylates, stearyl-polyethoxylated methylacrylates, eicosyl-polyethoxylated methacrylates, behenyl-polyethoxylated methacrylates, and mixtures thereof.

Anionic Monomers

In one embodiment, the acidic monomeric units each independently comprise, per monomeric unit, at least one group according to structure (A.I):

—R³²—R³¹ (A.I)

wherein
R³¹ is a moiety that comprises at least one carboxylic acid, sulfonic acid, or phosphoric acid group, and
R³² is absent or is a bivalent linking group.

In one embodiment, R³² is O, —(CH₂)ₙ—O—, or is according to structure (structure (A.II):

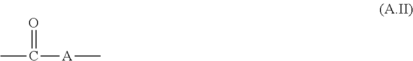

wherein:

n is an integer of from 1 to 6,

A is O or NR¹⁷, and

R¹⁷ is H or (C₁-C₄)alkyl.

In one embodiment, the acidic monomeric units each independently comprise one or two carboxy groups per monomeric unit and may, if the acidic monomeric unit comprises a single carboxy group, further comprise an ester group according to —CH₂COOR³³, wherein R³³ is alkyl, more typically, (C₁-C₆)alkyl.

The acidic monomeric units may be made by known synthesizing techniques, such as, for example, by grafting of one or more groups according to structure (A.I) onto a polymer backbone, such as a hydrocarbon polymer backbone, a polyester polymer backbone, or a polysaccharide polymer backbone. In the alternative, they may be made by polymerizing a monomer comprising a reactive functional group and at least one group according to structure (A.I) per molecule.

In one embodiment, the reactive functional group is an ethylenically unsaturated group so the monomer comprising a reactive functional group is an ethylenically unsaturated monomer. As a result the acidic monomer comprises at least one site of ethylenic unsaturation, more typically, an α-, β-unsaturated carbonyl moiety, and at least one group according to structure (A.I) per molecule and is copolymerizable with the nonionic monomer(s) and the hydrophobic monomer(s).

In one embodiment the acidic monomer comprises one or more ethylenically unsaturated monocarboxylic acid monomers according to structure (A.III):

R³⁴—R³²—R³¹ (A.III)

wherein:

R³¹ and R³² are each as described above, and

R³⁴ is a moiety having a site of ethylenic unsaturation.

In one embodiment, the compound according to structure (A.III) is an α-, β-unsaturated carbonyl compound. In one embodiment, R³⁴ is according to structure (A.IV):

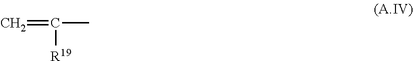

wherein R¹⁹ is H or (C₁-C₄)alkyl.

Suitable acidic monomers include, for example, ethylenically unsaturated carboxylic acid monomers, such as acrylic acid and methacrylic acid, ethylenically unsaturated dicarboxylic acid monomers, such as maleic acid and fumaric acid, ethylenically unsaturated alkyl monoesters of dicarboxylic acid monomers, such as butyl methyl maleate, ethylenically unsaturated sulphonic acid monomers, such as vinyl sulfonic acid 2-acrylamido-2-methylpropane sulfonic acid, and styrene sulfonic acid, and ethylenically unsaturated phosphonic acid monomers, such as vinyl phosphonic acid and allyl phosphonic acid, salts of any thereof, and mixtures of any thereof. Alternatively, corresponding ethylenically unsaturated anhydride or acid chloride monomers, such as maleic anhydride, may be used and subsequently hydrolyzed to give a pendant moiety having two acid groups. The preferred acidic monomeric units are derived from one or more monomers selected from acrylic acid, methacrylic acid, and mixtures thereof. Methacrylic acid has the following formula A.V:

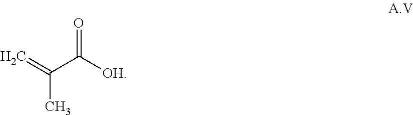

In one embodiment, the additional nonionic monomeric units each independently comprise, per monomeric unit, at least one group according to structure (B.I):

—R⁴²—R⁴¹ (B.I)

wherein
R⁴¹ is alkyl, hydroxyalkyl, alkoxyalkyl, cycloalkyl, aryl, arylalkyl, or aryloxy, and
R⁴² is absent or is a bivalent linking group.

In one embodiment, R⁴¹ is (C₁-C₂₂)alkyl, (C₁-C₂₂)hydroxyalkyl, (C₂-C₂₂)alkoxyalkyl, (C₆-C₂₄)cycloalkyl, (C₆-C₄₀)aryl, or (C₇-C₄₀)arylalkyl, more typically (C₂-C₁₂)alkyl.

In one embodiment, R⁴¹ is (C₁-C₂₂)alkyl, more typically, (C₁-C₁₂)alkyl.

In one embodiment, R⁴² is O, —(CH₂)ₙ—O—, wherein n is an integer of from 1 to 6, or is according to structure (B.II):

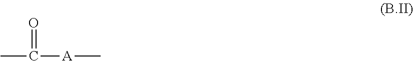

wherein:
n is an integer of from 1 to 6,

### A is O or NR¹⁷, and

R¹⁷ is H or (C₁-C₄)alkyl.

The nonionic monomeric units may be made by known synthesizing techniques, such as, for example, by grafting of one or more groups according to structure (B.I) onto a polymer backbone, such as a hydrocarbon polymer backbone, a polyester polymer backbone, or a polysaccharide polymer backbone, or a backbone made by polymerization with, for example, the above described acidic monomers and hydrophobic monomers, and at least one other monomer selected from monomers comprising a reactive functional group and at least one group according to structure (B.I) per molecule. Alternatively, the nonionic monomeric units may simply be non-grafted portions of a polymer backbone.

In one embodiment, the nonionic monomeric units are derived from a nonionic monomer, for example, ethyl acrylate, comprising a reactive functional group and a group according to structure (B.I), and copolymerizable with the acidic monomers and hydrophobic monomers.

In one embodiment, the reactive functional group of the nonionic monomer is an ethylenically unsaturated group and the nonionic monomer is an ethylenically unsaturated monomer comprising at least one site of ethylenic unsaturation, more typically, an α-, β-unsaturated carbonyl moiety and at least one group according to structure (B.I) per molecule.

In one embodiment, the nonionic monomer comprises one or more compounds according to structure (B.III):

R⁴³—R⁴²—R⁴¹ (B.III)

wherein:

R⁴¹ and R⁴² are each as described above, and
R⁴³ is a moiety having a site of ethylenic unsaturation.

In one embodiment, the compound according to structure (B.IIII) is an α-, β-unsaturated carbonyl compound. In one embodiment, R⁴³ is according to structure (B.IV):

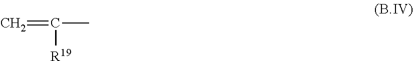

wherein R¹⁹ is H or (C₁-C₄)alkyl.

Suitable nonionic monomers include unsaturated monomers containing at least one group according to structure D.I per molecule, including (meth)acrylic esters such as: methyl (meth)acrylate, ethyl (meth)acrylate, butyl (meth)acrylate, isobutyl (meth)acrylate, cyclohexyl (meth)acrylate, 2-ethylhexyl (meth)acrylate, isodecyl (meth)acrylate, lauryl (meth)acrylate isobornyl (meth)acrylate, benzyl (meth)acrylate, hydroxyethyl (meth)acrylate, hydroxypropyl (meth)acrylate, methoxyethyl (meth)acrylate, ethoxyethyl (meth)acrylate, phenoxyethyl (meth)acrylate, tetrahydrofurfuryl (meth)acrylate, glycidyl (meth)acrylate, dimethylaminoethyl (meth)acrylate, diethylaminoethyl (meth)acrylate, tert-butylaminoethyl (meth)acrylate, and acetoxyethyl (meth)acrylate, (meth)acrylamides such as, (meth)acrylamide, N-methylol (meth)acrylamide, N-butoxyethyl (meth)acrylamide, N,N-dimethyl (meth)acrylamide, N-isopropyl (meth)acrylamide, N-tert-butyl (meth)acrylamide, N-tert-octyl (meth)acrylamide, and diacetone (meth)acrylamide, vinyl esters such as vinyl acetate, vinyl propionate, vinyl 2-ethylhexanoate, N-vinylamides such as: N-vinylpyrrolidione, N-vinylcaprolactam, N-vinylformamide, and N-vinylacetamide, and vinyl ethers such as, methyl vinyl ether, ethyl vinyl ether, butyl vinyl ether, and hydroxybutyl vinyl ether, and ethylenically unsaturated aryl compounds, such as styrene.

A method for the preparation of self-assembled particles induced macromolecular polymeric emulsifier by RAFT, characterized by comprising the steps of: (1) in two different hydrophilic and hydrophobic monomers as the raw material, is formed by amphiphilic molecules RAFT polymerization; (2) amphiphilic macromolecular chain transfer agent and a crosslinking agent RAFT polymerization reaction solvent, use of a crosslinking agent after crosslinking the polymeric core formed by the difference in solvent solubility directly induce the formation of colloidal particles, the reaction solution was dialyzed to remove unreacted monomers, to obtain colloidal particles dispersion; (3) to the dispersion of step (2) of the colloidal particles obtained as aqueous phase, and the oil phase were mixed by a volume ratio,

Polymer Compositions

In one embodiment, the polymer composition is in the form of an aqueous polymer dispersion, typically having a solids content including the polymer and any surfactants that may be present and based on the total weight of the polymer dispersion, of up to about 60 wt % and, more typically about 20 to about 50 wt %.

Experiments

PAA-Xa (i.e, PAA-Xanthate Moiety)

In a typical procedure, initial water, ethanol, Rhodixan A1, initial initiator V50 and 10 wt % of total acrylic acid, were introduced in a glass reactor, equipped with a mechanical stirrer and a condenser. After deoxygenation the mixture was heated and an aqueous solutions of acrylic acid and initiator were introduced separately in the reactor. The mixture was kept at polymerization temperature for several hours and then cooled down to room temperature.

| Reactant | | 16PDL019 | 16PDL021 | 16PDL022 |
|---|---|---|---|---|
| Acrylic Acid | Initial | 110 | 110 | 110 |
| | Feed (41 wt %) | 990 | 990 | 990 |
| Water | | 225.65 | 325.93 | 192.23 |
| V50 | Initial | 0.479 | 1.196 | 0.239 |
| | Feed (6 wt %) | 2.991 | 7.477 | 1.495 |
| Ethanol | | 301.57 | 435.58 | 256.90 |
| Rhodixan A1 | | 45.83 | 114.57 | 22.91 |
| Mₙ (kg/mol) | | 5.2 | 2.2 | 10.7 |
| PDI | | 1.37 | 1.37 | 1.29 |
| [AA]_{residual} | | 490 | 290 | 1020 |
| (ppm) | | | | |

PAM-Xa

In a typical procedure, initial water, ethanol, Rhodixan A1, initiator ACP and 10 wt % of total acrylamide (50 wt % in water) were introduced in a glass reactor, equipped with a mechanical stirrer and a condenser. After deoxygenation by nitrogen bubbling, the mixture was heated to greater than 50° C. and acrylamide was introduced in the reactor for greater than 1 hour. The mixture was kept at polymerization temperature and then cooled down to room temperature.

| Reactant | | 16EVN016 |
|---|---|---|
| Acrylamide | Initial | 80 |
| | Feed (50 wt %) | 720 |
| Water | | 203.42 |
| ACP | | 1.40 |
| Ethanol | | 250.85 |
| Rhodixan A1 | | 34.77 |
| Mₙ (kg/mol) | | |
| PDI | | |
| [AM]_{residual} | | |
| (ppm) | | |

PDMA-Xa

In a typical procedure, initial water, ethanol, Rhodixan A1, and 15 wt % of total dimethylacrylamide were introduced in a glass reactor, equipped with a mechanical stirrer and a condenser. After deoxygenation by nitrogen bubbling, aqueous solutions of ammonium persulfate APS (20 wt %), and hydroxymethane sulfonic acid sodium salt Dihydrate NaFS (2.5 wt %) were introduced shotwise. At the same time aqueous solution of DMA (40 wt %) and NaFS (2 wt %) were introduced in the reactor. The mixture was kept at polymerization temperature for more than 1 hour and then cooled down to room temperature.

| Reactant | | 16DTE032 |
|---|---|---|
| Dimethylacrylamide | Initial | 67.5 |
| | Feed (40 wt %) | 382.5 |
| Water | | 126.83 |
| APS | | 2.53 |
| NaFS | Initial | 0.0203 |
| | Feed (40 wt %) | 0.486 |
| Ethanol | | 124.34 |
| Rhodixan A1 | | 46.87 |
| Mₙ (kg/mol) | | |
| PDI | | |
| [DMA]_{residual} | | |
| (ppm) | | |

Latex Synthesis Via Seed:

De-ionized water and the macro CTA PAM-Xa (Polyacrylamide-xanthate) were added to a suitable reactor for emulsion polymerization equipped with agitation, heating and cooling means with a slow continuous nitrogen purge. Under continuous agitation, the temperature of the reactor was raised and a monomer mixture (9 g) of vinyl acetate, butyl acrylate, and acrylic acid was added to the reactor.

Once the temperature of the reactor had stabilized to less than 40° C., a solution of sodium metabisulfite (6.13 g) was added to the reactor, than a solution of ammonium persulfate was added.

The seed was kept at constant temperature and there was no observable change in color (bluish); however a slight exotherm of 1-2° C. was noticeable. A small sample was removed to check for particle size. The continuous addition of the remaining monomer mixture (171 g) was completed for several hours—a continuous addition of the remaining solution of ammonium persulfate (24.3 ml) and sodium metabisulfite. Once the monomer addition was completed, the rest of the remaining initiators were fed over a period of 30 minutes.

A total of 3 ml of FeCl3 solution (0.01 g of FeCl3 was diluted in 6.5 g of deionized water) was added (in 2 lots at 10 minute interval) to the reactor after the monomer additions with reactor. An hour into the addition of monomers and initiators, the temperature of the reactor was slowly. At the end of the monomer and initiators additions, the temperature of the reactor was increased slowly over 40 minutes to 80° C. The reactor was cooled and the resulting latex was filtered through a 136 um polyester filter. The polymer dispersion obtained had a solid content of 39.65%, and the average particle size was 113.0 d·nm. (diameter nm)

The physical properties of the latex are reported in table 1. Water sensitivity test is reported in table 1.1.

The solids content was determined in general by drying about 1 g of latex in an open aluminum pan in a drying oven set at 120° C. for an hour. The solids content was calculated by averaging three separate measurements.

The particle size of the resulting latex was determined by using Zetasizer Nano S from Malvern Instruments Ltd with standard methods and procedures for operation of the equipment. The sample was prepared by using one drop of latex in about 20 g deionized water. The sample was then well mixed before placing it in the cuvette.

The mechanical stability of the latex was evaluated by placing about 160 g of latex in a Commercial Waring Blender (single speed at 16,000 RPM) and blends the latex for five minutes. Failure of the latex is at the point latex became unstable and coagulates. If after 5 minutes, the latex did not coagulate, the content is filtered through a 136 um polyester filter.

The freeze-thaw stability of the aqueous polymer dispersion was measured by ASTM standard test method D-2243. The procedure for this ASTM method is as follows: the samples were placed in the freezer overnight at 0° F. (−18° C.) for 17 hours. The samples were then removed from the freezer the next day and were allowed to “thaw out” at room temperature for 7 hours. The samples were then well mixed by hand using a spatula before measuring the viscosity.

For salt tolerance test, a 5% wt. solution of CaCl2 was prepared in deionized water. About 60 g of latex was weighted out in a 200 mL plastic beaker. The latex solution was placed under a stir shaft and started mixing. Added drop wise of the CaCl2 solution into the latex and record the gram of solution was used. The solution is failed if the latex started to coagulate.

The viscosity of the resulting latex was determined by using a Brookfield DV2T Extra viscometer with spindle #31. The viscometer was operated at room temperature and at speed of 10 RPM.

The surface tension of the resulting latex was determined by using a KSV Tensiometer with standard procedure for the operation of the equipment. About 60 g of Latex was measured in a 100 g dish, and a DuNouy ring was used to measure the surface tension.

Water sensitivity of the resulting latex was determined by the following three methods:

Method 1: The resulting latex was draw down on a glass plate using a 8 ml bar for the film formation. After the film was dried in the room temperature for 2 days, several water drops were pipetted onto the dried film. Observe the discoloration after 10 minutes, and it was ranked based on 1 (fully discolored)-5 (no discoloration) scale.

Method 2: The resulting latex from method 1 was dried for 5 hours from the water spotting test. A water bath was prepared at room temperature, and parts of the films were submerged under the water. The films were checked after 24, 48, 72, and 96 hours. Again, same ranking was given as in method 1.

Method 3: Only films had the ranking of 4 or 5 from method 2 was tested under this method. Method 3 was adaptation of ASTM standard test method D 2247-15. The procedure for this method is as follows: A pan was filled with water and it was heated on a hot plate. The films were exposed to the heated and saturated mixture of air and water vapor for an hour. The films were ranked based on the same ranking as method 1.

### Example 1.1 (1298-182)

The preparation of example 1.1 was effected analogously to example 1 as repeat example. All processing was comparable.

The polymer dispersion obtained had a solid content of 39.17% and the average particle size was 119.4 d·nm. Various physical properties of the latex are reported in table 1. Water sensitivity test is reported in table 1.1.

### Example 1.2 (1341-05)

The preparation of example 1.2 was effected analogously to example 1. The process was modified to have an improved process for monomer conversion.

The polymer dispersion obtained had a solid content of 42.55% and the average particle size was 124.1 d·nm. Various physical properties of the latex are reported in table 1. Water sensitivity test is reported in table 1.1.

### Example 1.3

(S1313-141)

The preparation of example 1.3 was effected analogously to example 1, except 156.49 g of deionized water and 67.36 g (16% Based on Total Monomer) of PAM-Xa were initially added to the kettle charge. And a change in initiators from sodium metabisulphite to ascorbic acid, with a total of 0.162 g of ascorbic acid and 0.55 g of sodium bicarbonate in 30 g of deionized water.

The seed was kept at constant temperature for an hour. Evidence of the polymerization was observed by the appearance of white latex color 10 minutes into the monomer addition. The continuous addition of the remaining monomer mixture (171 g) occurred over several hours. 2 ml of FeCl3 solution was then added to the reactor. At end of the monomer and initiators additions, the temperature of the reactor was increased slowly to around 80° C. After cooling the reaction, 3 g of 20% ammonium hydroxide solution was added to the polymer dispersion.

The polymer dispersion obtained had a solid content of 29.91%, and the average particle size was 59.28 nm. Various physical properties of the latex are reported in table 1. Water sensitivity test is reported in table 1.1.

### Example 1.4

(1313-134)

The preparation of example 1.4 was effected analogously to example 1, except 174.05 g of deionized water and 68.8 g (16% Based on Total Monomer) of PAM-Xa were initially added to the kettle charge under continuous agitation. Monomer mixture was prepared under the same manner, except the monomer seed was the only composed of butyl acrylate and acrylic acid. A solution of ammonium persulfate was added to the kettle charge, followed by the monomer seed [5% of the butyl acrylate and acrylic acid monomer mixture].

The seed was kept at constant temperature for over 50 minutes. The continuous addition of the sodium bicarbonate (0.50 g of sodium bicarbonate was dissolved in 42.49 g of deionized water) was started to complete in three hours.

Fifty minutes into monomer addition, the temperature of the reactor was raised to 70° C. An hour later, the monomer addition was turned off due to a noticeable excessive exotherm and heavy reflux of monomers. Consequently also 80.97 g of deionized water was added, and the temperature of the reactor was decreased to 68.5° C. Monomer addition was resumed 45 minutes later. The polymer dispersion obtained had a solid content of 35.27%, and the average particle size was 78.3 d·nm. Various physical properties of the latex are reported in table 1. Water sensitivity test is reported in table 1.1.

### Example 1.5

(1298-176)

The preparation of example 1.5 was effected analogously to example 1, except 188.40 g of deionized water and 34.37 g (8% BOTM) of PAM-Xa were initially added to the kettle charge under continuous agitation. A monomer mixture was added to the reactor, followed by a solution of ammonium persulfate (6.13 g) [20% of the total solution of ammonium persulfate (0.17 g) and sodium bicarbonate (0.50 g) dissolved in deionized water (30.0 g)]. The seed was kept at constant temperature. Both monomer and initiator additions were kept at constant temperature.

The polymer dispersion obtained had a solid content of 42.68%, and the average particle size was 184.0 d·nm. Various physical properties of the latex are reported in table 1. Water sensitivity test is reported in table 1.1.

### Example 1.6

[S1336-88]

Deionized water (158.9 g.) with PAM-Xa (34.37 g.) was added to a suitable reactor equipped with agitation, heating and cooling means with a slow continuous nitrogen purge and stirred continuously at a slow agitation. A 5% monomer mixture of vinyl acetate, butyl acrylate and acrylic acid was added to the reactor for the seed stage. Then sodium metabisulfite solution, followed by ammonium persulfate solution, was added to the reactor.

The seed was allowed to react at constant temperature and a faint light bluish color was observed after an hour. Before starting the feed, FeCl3 was added to the reactor. The latex was cooled to below 40° C. and filtered through a 136 um polyester filter.

The final latex solids were 44.66%, pH of 1.89, viscosity of 2368 cps and particle size of 89.23 nm. The pH of the final latex was 1.89, and a small sample was taken and pH increased to 7.76 by adding ammonium hydroxide. The sample with higher pH exhibited very thick and gel-like properties. Physical properties of the latex are reported in table 1. Water sensitivity test is reported in table 1.1.

TABLE 1
PAM-XA in Va/Ba/AA system

| | | Monomer | Particle | | | | | Surface | | | Method |
|---|---|---|---|---|---|---|---|---|---|---|---|
| | % BOTM | % | size | Solids | Mechanical | | | Tension | Viscosity | Salt | of |
| Example | PAM-XA | seed | (d.nm) | % | stability | pH | Freeze/thaw | (mN/m) | (cP) | Tolerance | intiation |
| 1 | 8 | 5 | 113.0 | 39.65 | Passed | 4.76 | F | 50.254 | 198 | Did not | Redox |
| | | | | | | | | | | coagulate | |
| 1.1 | 8 | 5 | 119.4 | 39.17 | — | 4.43 | — | 35.09 | — | — | Redox |
| 1.2 | 8 | 5 | 124.1 | 42.55 | passed | 4.79 | — | 50.36 | 1704 | — | Redox |
| 1.3 | 16 | 5 | 59.28 | 29.91 | passed | 4.64 | F | 43.73 | 519 | — | Redox |
| 1.4 | 16 | 5 | 78.3 | 35.27 | passed | 4.75 | — | — | >3000 | — | Thermal |
| 1.5 | 8 | 5 | 184 | 42.68 | passed | 4.71 | — | 53.32 | 393.0 | — | Thermal |
| 1.6 | 8 | 5 | 89.26 | 44.66 | passed | 1.89 | — | — | 2368 | — | Redox |
| Comparative | (surfactant) | 5 | 110.5 | 43.20 | passed | 9.01 | — | 31.502 | 93 | Did not | Thermal |
| example 1 | | | | | | | | | | coagulate | |
| Comparative | (surfactant) | 5 | 113.4 | 47.0 | failed | 8.82 | — | | 208 | — | Redox |
| example 2 | | | | | | | | | | | |

TABLE 1.1
Water sensitivity for films made
from PAM-XA in VA/BA/AA System

| | | Water bath test | |
|---|---|---|---|
| Example | Water spot test | (after 96 hours) | Water vapor test |
| 1 | 5 | 5 | 5 |
| 1.1 | 5 | 5 | 5 |
| 1.2 | 5 | 5 | 5 |
| 1.3 | 2 | 2 | N/A |
| 1.4 | 2 | 3 | N/A |
| 1.5 | 1.5 | 1.5 | N/A |
| 1.6 | 5 | | |
| Comparative | 3 | 1 | 1 |
| example 1 | | | |
| Comparative | 2 | | |
| example 2 | | | |

### Example 2 (PAM in all Acrylic) (S1341-39)

Preparation of the Latex Via Seed:

Deionized water (238.38 g) was initially added to a suitable reactor for emulsion polymerization equipped with agitation, heating and cooling means with a slow continuous nitrogen purge. Under continuous agitation, the temperature of the reactor was raised and the macro CTA PAM-Xa (76.8 g) was added to the reactor. Once the temperature was stabilized at constant temperature, the monomer mixture methyl acrylate, butyl acrylic, and acrylic acid was added. Then a solution of ammonium persulfate (0.37 g of ammonium persulfate was dissolved in 1.187 g of deionized water) was added to the reactor. Evidence of the polymerization was observed by the appearance of the light blue tint color in the reactor after 1 minutes of the initiator addition.

For this particular example, the resulting latex dispersion had reached to theoretical solid content right after addition of monomer. The reaction was then cooled and the resulting latex was bottled (No filter was used due to high viscosity). The polymer dispersion obtained had a solid content of 45.65% and the average particle size was 106.8 d·nm. Various physical properties of the latex are reported in table 2, and all test methods are the same as in example 1, except viscosity. Instead of using Brookfield DV2T Extra viscometer with spindle #31, this run was tested using Brookfield Model DV II with spindle LV 2C and 10 RPM.

TABLE 2
PAM-XA in all acrylic system

| | BOTM | | Particle | | | | | Surface | | |
|---|---|---|---|---|---|---|---|---|---|---|
| | % PAM- | Monomer | size | | | | Freeze/ | Tension | Viscosity | Salt |
| Example | XA | seed % | (d · nm) | Solids % | Mecstability | pH | thaw | (mN/m) | (cP) | Tolerance |
| 2 | 16 | 5 | 106.8 | 45.65 | — | 2.56 | — | N/A | 17790 | — |
| | | | | | | | | (latex | | |
| | | | | | | | | too | | |
| | | | | | | | | thick) | | |

The film of the latex was not prepared, as the latex was too high in viscosity.

### Example 3 (PAA-XA in Styrene/BA) (S1313-55)

Preparation of the Latex Via Seed:

Deionized water (298.62 g) was initially added to a suitable reactor for emulsion polymerization equipped with agitation, heating and cooling means with a slow continuous nitrogen purge. Under continuous agitation, the temperature of the reactor was raised, a monomer mixture of styrene and butyl acrylate was added to the reactor, followed by the macro CTA PAA-XA (polyacrylic acid-xanthate, 50% solids). Once the temperature of the reactor had stabilized, a solution of ammonium persulfate was added to the reactor. Evidence of the polymerization was observed by the appearance of the blue tint color in the reactor after 5 minutes of the initiator addition. Continuous addition of the remaining monomer mixture was started to complete over several hours at varying rates.

When the monomer addition was finished, a small sample of aqueous polymer dispersion was obtained to do a solid content. If the solid content has reached to theoretical solid, then the reaction was cooled, and the resulting latex was filtered through a 136 um polyester filter. If the solid content was not at the theoretical solid, then the aqueous polymer dispersion was further reacted until the theoretical solid is reached.

For this particular example, the latex polymer dispersion had reached to theoretical solid content right after addition of monomer. The reaction was then cooled and the resulting latex was filter using 136 um polyester filter. The polymer dispersion obtained had a solid content of 41.063% and the average particle size was 108.8 d·nm. Various physiochemical properties of the latex are reported in table 3, and all test methods are the same as in example 1, except viscosity. Instead of testing at 10 RPM, the examples in 2 were tested at 20 RPM.

For water sensitivity test, only method 1 was applied, and the results were based on 2 minutes time frame. The results of the latex are recorded in table 3.1.

### Example 3.1 (S1313-67)

The preparation of example 3.1 was effected analogously to example 3. All process was comparable.

The polymer dispersion obtained had a solid content of 41.77% and the average particle size was 147.04 d·nm. Various physical properties of the latex are reported in table 3. Water sensitivity test is reported in table 3.1.

### Example 3.2 (1298-159)

The preparation of example 3.2 was effected analogously to example 3, except only 2.8 g (2% of the total monomer weight) of monomer mixture was initially added to the reactor, and the ammonium persulfate solution was continuously added along with the monomer mixture. The aqueous polymer dispersion was further heated at constant temperature for an hour before cooling. The polymer dispersion obtained had a solid content of 38.99% and the average particle size was 116.3 d·nm. Various physical properties of the latex are reported in table 3. Water sensitivity test is reported in table 3.1.

### Example 3.3 (1313-92)

The preparation of example 3.3 was effected analogously to example 3. The weight percentage of this example was 70% of the original weight. Except only 0.7 g (0.5% of the total monomer weight) of monomer mixture was initially added to the reactor. No evidence of blue tint was observed after the addition of the ammonium persulfate solution.

However, evidence of the polymerization was observed by the appearance of the light blue color in the reactor 5 minutes after the monomer addition. The polymer dispersion obtained had a solid content of 39.21% and the average particle size was 197.8 d·nm. Various physical properties of the latex are reported in table 3. Water sensitivity test is reported in table 3.1.

### Example 3.4 (1313-58)

The preparation of example 3.4 was effected analogously to example 3, except only 32.0 g (8% based on the total monomer) of PAA-XA was initially added to the reactor. The aqueous polymer dispersion was further heated for an hour at high temperature before cooling.

The polymer dispersion obtained had a solid content of 39.93% and the average particle size was 155.3 d·nm. Various physical properties of the latex are reported in table 3. Water sensitivity test is reported in table 3.1.

### Example 3.5 (1313-49)

The preparation of example 3.5 was effected analogously to example 3. Except only 4.0 g (2% of the total monomer weight) monomer mixture was initially added to the reactor. The aqueous polymer dispersion was further heated for an hour at high temperature before cooling. The polymer dispersion obtained had a solid content of 39.55% and the average particle size was 120.6 d·nm. Various physical properties of the latex are reported in table 3. Water sensitivity test is reported in table 3.1.

### Example 3.6 (1313-45)

The preparation of example 3.6 was effected analogously to example 3. Except only 20.0 g (10% of the total monomer weight) monomer mixture was initially added to the reactor.

The aqueous polymer dispersion was further heated and after, a solution of ammonium persulfate was added to the reactor to increase the rate of polymerization. The reactor was heated for additional hour at high temperature.

The polymer dispersion obtained had a solid content of 40.43% and the average particle size was 255.4 d·nm. Various physical properties of the latex are reported in table 3. Water sensitivity test is reported in table 3.1.

TABLE 3
PAA-XA in styrene/ba system

| | % | | | | | | | | | |
|---|---|---|---|---|---|---|---|---|---|---|
| | BOTM | | Particle | | | | | | Surface | |
| | PAA- | monomer | size | | Mechanical | | Freeze/ | Viscosity | Tension | Salt |
| Example | XA | seeds % | (d · nm) | Solids % | stability | pH | thaw | (cP) | (mN/m) | tolerance |
| 3 | 16 | 5 | 108.8 | 41.063 | passed | 2.02 | F | 55 | 63.702 | — |
| 3.1 | 16 | 5 | 147.04 | 41.77 | Passed | — | F | 24 | 54.571 | — |
| 3.2 | 16 | 2 | 116.3 | 38.99 | passed | 2.19 | — | 21 | 59.629 | — |
| 3.3 | 16 | 0.5 | 197.8 | 39.21 | passed | 2.25 | P | 12 | 50.405 | — |
| 3.4 | 8 | 5 | 155.3 | 39.93 | Failed | 2.03 | F | 21 | 58.825 | — |
| 3.5 | 16 | 2 | 120.6 | 39.55 | passed | 2.02 | — | 33 | 50.155 | Did |
| | | | | | | | | | | not |
| | | | | | | | | | | coagulate |
| 3.6 | 16 | 10 | 255.4 | 40.43 | passed | 1.9 | p | 15 | 54.215 | — |

TABLE 3.1
Water sensitivity test for films made
from PAA-XA in styrene/ba system

| | % BOTM | monomer | |
|---|---|---|---|
| Example | PAA-XA | seeds % | Water spot test |
| 3 | 16 | 5 | 5 |
| 3.1 | 16 | 5 | 5 |
| 3.3 | 16 | 2 | 5 |
| 3.4 | 16 | 0.5 | 1 |
| 3.4 | 8 | 5 | 4.5 |
| 3.5 | 16 | 2 | 5 |
| 3.6 | 16 | 10 | 1 |

### Example 4 (PDM in Styrene/BA)

(1341-01)

Preparation of the Seed:

Deionized water (315.05 g) was initially added to a suitable reactor for emulsion polymerization equipped with agitation, heating and cooling means with a slow continuous nitrogen purge. Under continuous agitation, the temperature of the reactor was raised and a monomer mixture of styrene and butyl acrylate was added to the reactor, followed by the macro CTA PDM-XA (polydimethaminoacrylamide-xanthate). Once the temperature of the reactor had stabilized, a solution of ammonium persulfate was added to the reactor. Evidence of the polymerization was observed by the appearance of the blue tint color in the reactor after 2 minutes of the initiator addition.

The seed was kept at high temperature for an hour. The latex had the solid content of 39.15% by weight, based on the total weight of the aqueous dispersion. The mean particle size of the polymer was 124.4 d·nm.

Various physical properties of the latex are reported in table 4. Water sensitivity test is reported in table 4.1. All test methods are followed in example 1.

### Example 4.1 (S1341-43)

The preparation of example 4.1 was effected analogously to example 4. Except only 32.9 g of macro CTA PDM-XA (polydimethaminoacrylamide) was added to the reactor.

The aqueous polymer dispersion did not reach to theoretical solid after the monomer addition, and it was further heated at high temperature. A solution of ammonium persulfate was added to the reactor to increase the solids. The aqueous polymer dispersion was further heated for additional hours before cooling, and the resulting latex was filter using 136 um polyester filter.

The particle size of the resulting latex was 603.2 d·nm. However, the latex was found to be unstable overtime.

TABLE 4
PDM-XA in Styrene/BA system

| | % | | | | | | | | | |
|---|---|---|---|---|---|---|---|---|---|---|
| | BOTM | | Particle | | | | | Surface | | |
| | PDM- | monomer | size | | Mechanical | | Freeze/ | Tension | Viscosity | Salt |
| Example | XA | seeds % | (d · nm) | Solids % | stability | pH | thaw | (mN/m) | (cP) | Tolerance |
| 4 | 16 | 5 | 124.4 | 39.15 | passed | 2.47 | F | 60.296 | 306 | passed |
| 4.1 | 8 | 5 | 603.2 | Unstable | — | — | — | — | — | — |

TABLE 4.1
PDM-XA in Styrene/BA system

| | | Water bath test | |
|---|---|---|---|
| Example | Water spot test | (after 96 hours) | Water vapor test |
| 4 | 4 | 5 | 5 |

### Comparative Example 1 (1298-102)

The resulting latex was used as a control for example 1, 1.1, 1.2, 1.3, 1.4, 1.5, and 1.6.

Deionized water (114.2 g) and Tridecyl 30 EO sulfate (4.96 g) [0.70% Based on the total monomer] were initially added to a suitable reactor for emulsion polymerization equipped with agitation, heating and cooling means with a slow continuous nitrogen purge. Under continuous agitation, the temperature of the reactor was raised, and a monomer pre-emulsion [deionized water, Tridecyl 30 EO sulfate, methyl methacrylate, butyl acrylate, and methacrylic acid] was added to the reactor (the pre-emulsion was neutralized to a pH about 7 with 20% ammonium hydroxide).

Once the temperature of the reactor had stabilized, a solution of ammonium persulfate was added to the reactor. The seed was kept at constant temperature and a small sample was removed to check for particle size. After the initiator addition completed, the temperature of the reactor was raised and held it for additional 30 minutes. The reactor was then cooled and the pH of the aqueous polymer dispersion was then adjusted to pH 9.01.

The resulting latex product was completely removed from the reactor and filtered through a 136 um polyester filter.

The latex had the solid content of 43.20% by weight, based on the total weight of the aqueous dispersion. The mean particle size of the polymer was 110.5 d·nm.

Various physical properties of the latex are reported in table 1. Water sensitivity test is reported in table 1.1.

### Comparative Example 2: [S1336-75]

The resulting latex was used as a control for example 1, 1.1, 1.2, 1.3, 1.4, 1.5, and 1.6.

Deionized water (78 g), Sodium C14-16 Olefin sulfonate (2.5 g), sodium bicarbonate (0.125 g), and ferric chloride (1.25 g) [0.005 g FeCl3 in 5 ml of water] were added to a suitable reactor for emulsion polymerization equipped with agitation, heating and cooling means, and a slow continuous nitrogen purge. Under continuous agitation, the temperature of the reactor was raised and 5% of the monomer pre-emulsion (17.49 g) (consisting of deionized water (90 ml), Sodium C14-16 Olefin sulfonate (9.375 g), sodium bicarbonate (0.375 g), vinyl acetate (147.5 g), butyl acrylate (100 g), and acrylic acid (2.5 g) was added. The pre-emulsion was judged to be stable before being added to the reactor. After 5 minutes, 20% (8.10 g) of a solution of sodium metabisulfite (0.875 g of sodium metabisulfite dissolved in 40.0 g of deionized) was added to the reactor, followed by 20% (8.04 g) of a solution of ammonium persulfate (1.276 g of ammonium persulfate dissolved in 40.0 g of deionized water).

The seed was allowed to react at constant temperature (particle size z-average of 74.94 d·nm). Redox post addition was then initiated, with a solution of sodium metabisulfite (0.15 g) and deionized water (2.5 ml), followed by a solution of tert-butyl hydro peroxide (0.215 g) and water (2.5 ml), added slowly to avoid to avoid any excessive exotherms. The latex was cooled and filtered through a 136 um polyester filter. The solids were at 47.0%, pH of 5.22 with particle size of 113.4 d·nm. And the latex was adjusted with ammonium hydroxide to a pH of 8.82 that viscosity of 208 cps.

### Example 5 (S1341-100)

De-ionized water and the Macro CTA PAM-Xa (Polyacrylamide xanthate) were added to a suitable reactor for emulsion polymerization equipped with agitation, heating and cooling means with a slow continuous nitrogen purge. Under continuous agitation, the temperature of the reactor was raised and a monomer mixture of vinyl acetate, butyl acrylate, and acrylic acid was added to the reactor.

Once the temperature of the reactor had stabilized, a solution of sodium metabisulphite was added to the reactor, after which time a solution of ammonium persulfate was added. The seed was kept at constant temperature for 40 minutes. There was no observable change in color (bluish); however a slight exotherm of 1-2° C. was noticeable. A small sample was removed to check for particle size.

3 ml of a FeCl3 solution was added to the reactor. An hour into the addition of monomers and initiators, the temperature of the reactor was slowly raised.

The reactor was then cooled and the resulting latex was filtered through a 136 um polyester filter. The polymer dispersion obtained had a solid content of 44.34%, and the average particle size was 121.7 d·nm.

### Comparative Example 5C1 (S1336-68)

Deionized water, Sodium C14-16 Olefin sulfonate, and sodium bicarbonate were added to a suitable reactor for emulsion polymerization equipped with agitation, heating and cooling means with a slow continuous nitrogen purge. Under continuous agitation, the temperature of the reactor was raised and a monomer pre-emulsion [deionized water, Sodium C14-16 Olefin sulfonate, sodium bicarbonate, vinyl acetate, butyl acrylate, and acrylic acid] was added to the reactor (the pre-emulsion was stabilized before adding), followed by a solution of ammonium persulfate. The seed was kept at constant temperature for 15 minutes. The polymer dispersion obtained had a solid content of 47.89%, the average particle size was 103.3 d·nm and a pH of 4.95.

### Comparative Example 5C2: Encor 310 from Arkema as Commercial Vinyl Acrylic Binder Control

TABLE 5
Latex properties:

| | Particle | | | | |
|---|---|---|---|---|---|
| | Size, d · nm | Solids, % | pH | coagulum | Viscosity |
| Example 5 | 121.7 | 44.34 | 4.94 | 0.114 | 549.0 |
| Comparative | 103.3 | 47.89 | 4.95 | 0.01 | 3040 |
| example 5C1 | | | | | |
| Comparative | | | | | |
| example 5C2 | | | | | |
| (commercial | | | | | |
| latex) | | | | | |

Paint Formulation:

The latex sample prepared from example 5, the comparable example 5C1, and 5C2 were used to prepare architectural paints. The paint formulation is shown in the following table 5.1.

TABLE 5.1
Paint formulation.

| | | Comparative | Comparative |
|---|---|---|---|
| Raw Material | Example 5 | example 5C1 | example 5C2 |
| Pigment Grind | | | |
| Water | 10.76 | 10.76 | 10.76 |
| Natrosol Plus 330 | 0.13 | 0.13 | 0.13 |
| AMP-95 | 0.12 | 0.12 | 0.12 |
| Acticide BW-20 | 0.18 | 0.18 | 0.18 |
| Dispersant | 0.63 | 0.63 | 0.63 |
| Defoamer | 0.18 | 0.18 | 0.18 |
| Wetting agent | 0.27 | 0.27 | 0.27 |
| CaCO3 #10 white | 10.76 | 10.76 | 10.76 |
| Kaolin | 5.65 | 5.65 | 5.65 |
| Organic Clay | 0.36 | 0.36 | 0.36 |
| Letdown | | | |
| Ti-Pure R-746 | 23.31 | 23.31 | 23.31 |
| Water | 6.53 | 6.53 | 6.53 |
| Latex Resins | 32.73 | 32.73 | 32.73 |
| Coalescent | 1.35 | 1.35 | 1.35 |
| AMP-95 | 0.05 | 0.05 | 0.05 |
| Defoamer | 0.27 | 0.27 | 0.27 |
| Thickner | 0.13 | 2.39 | 3.14 |
| Water | 5.24 | 1.33 | 3.58 |
| Total | 100 | 100 | 100 |
| Properties: | | | |
| PVC, % | 40.46 | | |

The liquid paint properties were measured in the following table 5.2.

TABLE 5.2
Liquid Paint Performance Properties

Samples

| | | Comparative | Comparative |
|---|---|---|---|
| | Example 5 | example 5C1 | example 5C2 |
| Initial properties | | | |
| KU viscosity | 105 | 100.2 | 101.1 |
| ICI viscosity, poise | 1.2 | 1.6 | 1.4 |
| pH | 8.61 | 9.12 | 9.02 |
| Equilibrated | | | |
| properties | | | |
| KU viscosity | 119 | 110 | 125/121 |
| ICI viscosity, poise | 2.1 | 1.8 | 1.34 |
| pH | 8.28 | 9.34 | 9.01 |

Dry paint performance was further evaluated and the properties were given in table 5.3.

TABLE 5.3
Properties of dry paint

| | Samples | | |
|---|---|---|---|
| | | Comparative | Comparative |
| | Example 5 | example 5C1 | example 5C2 |
| Gloss, 60° | 5.0 | 5.0 | 5.0 |
| Sag | 24 | 12 | 12 |
| Flow | 3 | 7 | 8 |
| Opacity -Hiding | 97.85 | 97.21 | 96.59 |
| Block Resistance | | | |
| 1 day, RT/Oven | 10/7 | 10/2 | 6/2 |
| 7 days, RT/Oven | 10/9 | 10/6 | 9/4 |
| Stain Test | | | |
| % removed hydrophobic | 58.33 | 20.83 | 45 |
| % removed hydrophilic | 81.25 | 72.5 | 37.5 |

Referring to Table 5.3, Sag refers to the resistance a coating has to undesired flow when applied to a surface. For example, when paints are painted on a wall for instance, they tend to sag when first applied, and then flow. The optimized paint usually has good sag and flow resistance. The coating made in Example 5 exhibited showed a higher sag value as compared to the comparative example (wherein the sag resistance equals twice as better resistance).

Opacity: the term used to describe the hiding strength of paint films. It is an indication of how well the pigments are dispersed; the higher the percentage, >96%, the better the hiding.

Block Resistance: This method is used to test the resistance of dry paint films to adhere to each other. When two dry paints come together in contact with each other, the paints exhibit the undesired effect of blocking, i.e., sticking to itself/each other. Referring back to Table 5.3, a Block value of 10 means the block resistance is very good, indicating the two films do not stick together. A block Value 1 means the two dry films stick together when in contact, so it is the least favorable value. As seen in the table, the Block resistance of the coatings made in Example 5 show block values of 7 and 9 out of 10, for 1 day and 7 days, respectively. By contrast, the Block resistance of comparative example 5C1 shows block values of 2 and 6 out of 10, for 1 day and 7 days, respectively. By contrast, the Block resistance of comparative example 5C1 shows block values of 2 and 4 out of 10, for 1 day and 7 days, respectively. Both comparative examples are far lower (i.e., worse) than the block values for example 5.

Stain test is to test the different hydrophobic (oil based material like lip sticks) and hydrophilic (water based material like tea) materials on the dry paints. The percentage removed indicates how much hydrophobic and hydrophilic residuals can be wiped off. Higher the percentage, the better the stain resistance. Example 5 exhibits better stain resistance.

It should be apparent that embodiments and equivalents other than those expressly discussed above come within the spirit and scope of the present invention. Thus, the present invention is not limited by the above description but is defined by the appended claims.

What is claimed is:

1. An aqueous composition comprising:
water;
optionally, a pigment; and
a film-forming latex composition with modified surface chemistry obtained by free-radical emulsion polymerization in the presence:
of at least one ethylenically unsaturated monomer or at least one polymer containing residual ethylenically unsaturated bonds,
of at least one free-radical polymerization initiator, and
of at least one water-soluble and/or water-dispersible polymer of formula (Ia) or formula (Ib):
(R¹¹)x-Z¹¹—C(═S)—Z¹²-[A]-[B]-R¹² (Ia), or
(R¹¹)x-Z¹¹—C(═S)—Z¹²-[B]-R¹² (Ib)
wherein:
Z¹¹ represents C, N, O, S or P,
represents S or P,
R¹¹ and R¹², which may be identical or different, represent:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii),
these groups (1) rings (i) or heterocycles (iii) being optionally substituted with substituted phenyl groups, substituted aromatic groups or groups selected from:
alkoxycarbonyl or aryloxycarbonyl (—COOR) groups,
carboxyl (—COOH) groups,
acyloxy (—O₂CR) groups,
carbamoyl (—CONR₂) groups,
cyano (—CN) groups,
alkylcarbonyl groups,
alkylarylcarbonyl groups,
arylcarbonyl groups,
arylalkylcarbonyl groups,
phthalimido groups,
maleimido groups,
succinimido groups,
amidino groups,
guanidimo groups,
hydroxyl (—OH) groups,
amino (—NR₂) groups,
halogen groups,
allyl groups,
epoxy groups,
alkoxy (—OR) groups,
S-alkyl groups,
S-aryl groups,
alkali metal salts of carboxylic acids,
alkali metal salts of sulphonic acid,
polyalkylene oxide (PEO or PPO) chains, and
quaternary ammonium salts,
wherein R represents an alkyl or aryl group,
x corresponds to the valency of Z¹¹, or alternatively x is 0, in which case Z¹¹ represents a phenyl, alkene or alkyne radical, being optionally substituted with groups selected from:
an optionally substituted alkyl, acyl, aryl, alkene or alkyne group,
an optionally substituted, saturated, unsaturated, or aromatic, carbon-based ring,
an optionally substituted, saturated or unsaturated heterocycle; an alkoxycarbonyl or aryloxycarbonyl (—COOR) group,
a carboxyl (COOH) group,
an acyloxy (—O₂CR) group,
a carbamoyl (—CONR₂) group,
a cyano (—CN) group;
an alkylcarbonyl group;
an alkylarylcarbonyl group;
an arylcarbonyl group;
an arylalkylcarbonyl group;
a phthalimido group,
a maleimido group,
a succinimido group,
a amidino group,
a guanidimo group,
a hydroxyl (—OH) group,
an amino (—NR₂) group,
a halogen group,
an allyl group,
an epoxy group,
an alkoxy (—OR) group,
a S-alkyl group,
a S-aryl group,
an alkali metal salt of carboxylic acid,
an alkali metal salt of sulphonic acid,
polyalkylene oxide (PEO or PPO) chains, and
quaternary ammonium salts,
wherein R represents an alkyl or aryl group;
A is a monoblock, diblock or triblock polymer comprising at least a first block which is hydrophobic in nature; and
B is a monoblock, diblock or triblock polymer comprising at least one monomer of vinyl acetate.

2. The aqueous composition of claim 1 wherein the film-forming latex composition with modified surface chemistry is obtained by free-radical emulsion polymerization in the absence of a surfactant.

3. The aqueous composition of claim 1 wherein the at least one water-soluble and/or water-dispersible polymer of formula (Ia) or formula (Ib) has a weight average molecular weight of from 5,000 to 7,000 Daltons.

4. The aqueous composition of claim 1 wherein the at least one ethylenically unsaturated monomer comprises:
(a) at least one first monomer selected from: methyl (meth)acrylate, ethyl (meth)acrylate, butyl (meth)acrylate, isobutyl (meth)acrylate, cyclohexyl (meth)acrylate, 2-ethylhexyl (meth)acrylate, isodecyl (meth)acrylate, lauryl (meth)acrylate isobornyl (meth)acrylate, benzyl (meth)acrylate, hydroxyethyl (meth)acrylate, hydroxypropyl (meth)acrylate, methoxyethyl (meth)acrylate, ethoxyethyl (meth)acrylate, phenoxyethyl (meth)acrylate, tetrahydrofurfuryl (meth)acrylate, glycidyl (meth)acrylate, dimethylaminoethyl (meth)acrylate, diethylaminoethyl (meth)acrylate, tert-butylaminoethyl (meth)acrylate, and acetoxyethyl (meth)acrylate, (meth)acrylamides such as, (meth)acrylamide, N-methylol (meth)acrylamide, N-butoxyethyl (meth)acrylamide, N,N-dimethyl (meth)acrylamide, N-isopropyl (meth)acrylamide, N-tert-butyl (meth)acrylamide, N-tert-octyl (meth)acrylamide, diacetone (meth)acrylamide, vinyl propionate, vinyl 2-ethylhexanoate, N-vinylamides such as: N-vinylpyrrolidione, N-vinylcaprolactam, N-vinylformamide, and N-vinylacetamide, methyl vinyl ether, 2-phosphate ethylene methacrylate, 2-sulphoethylene methacrylate, ethyl vinyl ether, butyl vinyl ether, hydroxybutyl vinyl ether, and styrene; and
(b) at least one second monomer selected from: acrylic acid, methacrylic acid, itaconic acid, maleic acid, fumaric acid, butyl methyl maleate, vinyl sulfonic acid 2-acrylamido-2-methylpropane sulfonic acid, styrene sulfonic acid, vinyl phosphonic acid, vinylbenzenesulphonic acid, α-acrylamidomethyl propanesulphonic acid, allyl phosphonic acid, and salts of any thereof.

5. The latex composition of claim 1 wherein the at least one ethylenically unsaturated monomer comprises:
(a) a first monomer selected from vinyl acetate; and
(b) at least one second monomer selected from: acrylic acid, methacrylic acid, maleic acid, fumaric acid, butyl methyl maleate, vinyl sulfonic acid, 2-acrylamido-2-methylpropane sulfonic acid, styrene sulfonic acid, vinyl phosphonic acid, vinylbenzenesulphonic acid, α-acrylamidomethyl propanesulphonic acid, allyl phosphonic acid, and salts of any thereof.

6. The aqueous composition of claim 1 further comprising at least one additive selected from the group consisting of dispersants, surfactants, rheology modifiers, defoamers, thickeners, biocides, mildewcides, colorants, waxes, perfumes and co-solvents.

7. A process for preparing an aqueous polymer dispersion, the process comprising the step of:
contacting the compound of formula (Ia) or formula (Ib) in an aqueous polymerization medium with at least one ethylenically unsaturated monomers and at least one free radical initiator;
thereby allowing free-radical polymerization of the ethylenically unsaturated monomers.

8. An aqueous composition comprising:
water;
optionally, a pigment; and
a film-forming latex composition with modified surface chemistry obtained by free-radical emulsion polymerization in the presence:
of at least one ethylenically unsaturated monomer or at least one polymer containing residual ethylenically unsaturated bonds,
of at least one free-radical polymerization initiator, and
of at least one water-soluble and/or water-dispersible polymer of formula (I):
(R¹¹)x-Z¹¹—C(═S)—Z¹²-[A]-R¹² (I)
wherein:
Z¹¹ represents C, N, O, S or P,
Z¹² represents S or P,
R¹¹ and R¹², which may be identical or different, represent:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii),
these groups (1) rings (i) or heterocycles (iii) being optionally substituted with substituted phenyl groups, substituted aromatic groups or groups selected from:
alkoxycarbonyl or aryloxycarbonyl (—COOR) groups,
carboxyl (—COOH) groups,
acyloxy (—O₂CR) groups,
carbamoyl (—CONR₂) groups,
cyano (—CN) groups,
alkylcarbonyl groups,
alkylarylcarbonyl groups,
arylcarbonyl groups,
arylalkylcarbonyl groups,
phthalimido groups,
maleimido groups,
succinimide groups,
amidino groups,
guanidimo groups,
hydroxyl (—OH) groups,
amino (—NR₂) groups,
halogen groups,
allyl groups,
epoxy groups,
alkoxy (—OR) groups,
S-alkyl groups,
S-aryl groups,
alkali metal salts of carboxylic acids,
alkali metal salts of sulphonic acid,
polyalkylene oxide (PEO or PPO) chains, and
quaternary ammonium salts,
wherein R represents an alkyl or aryl group,
x corresponds to the valency of Z¹¹, or alternatively x is 0, in which case Z¹¹ represents a phenyl, alkene or alkyne radical, being optionally substituted with groups selected from:
an optionally substituted alkyl, acyl, aryl, alkene or alkyne group,
an optionally substituted, saturated, unsaturated, or aromatic, carbon-based ring,
an optionally substituted, saturated or unsaturated heterocycle; an alkoxycarbonyl or aryloxycarbonyl (—COOR) group,
a carboxyl (COOH) group,
an acyloxy (—O₂CR) group,
a carbamoyl (—CONR₇) group,
a cyano (—CN) group;
an alkylcarbonyl group;
an alkylarylcarbonyl group;
an arylcarbonyl group;
an arylalkylcarbonyl group;
a phthalimido group,
a maleimido group,
a succinimido group,
a amidino group,
a guanidimo group,
a hydroxyl (—OH) group,
an amino (—NR₂) group,
a halogen group,
an allyl group,
an epoxy group,
an alkoxy (—OR) group,
a S-alkyl group,
a S-aryl group,
an alkali metal salt of carboxylic acid,
an alkali metal salt of sulphonic acid,
polyalkylene oxide (PEO or PPO) chains, and
quaternary ammonium salts,
wherein R represents an alkyl or aryl group; and
A represents a monoblock, diblock or triblock polymer comprising at least a first block which is hydrophilic in nature and a second block which is hydrophobic in nature.

9. The aqueous composition of claim 8 wherein the film-forming latex composition with modified surface chemistry is obtained by free-radical emulsion polymerization in the absence of a surfactant.

10. The aqueous composition of claim 8 wherein the at least one water-soluble and/or water-dispersible polymer comprising formula (I) has a weight average molecular weight of from 5,000 to 7,000 Daltons.

11. The aqueous composition of claim 8 wherein the at least one ethylenically unsaturated monomer comprises:
(a) at least one first monomer selected from: methyl (meth)acrylate, ethyl (meth)acrylate, butyl (meth)acrylate, isobutyl (meth)acrylate, cyclohexyl (meth)acrylate, 2-ethylhexyl (meth)acrylate, isodecyl (meth)acrylate, lauryl (meth)acrylate isobornyl (meth)acrylate, benzyl (meth)acrylate, hydroxyethyl (meth)acrylate, hydroxypropyl (meth)acrylate, methoxyethyl (meth)acrylate, ethoxyethyl (meth)acrylate, phenoxyethyl (meth)acrylate, tetrahydrofurfuryl (meth)acrylate, glycidyl (meth)acrylate, dimethylaminoethyl (meth)acrylate, diethylaminoethyl (meth)acrylate, tert-butylaminoethyl (meth)acrylate, and acetoxyethyl (meth)acrylate, (meth)acrylamides such as, (meth)acrylamide, N-methylol (meth)acrylamide, N-butoxyethyl (meth)acrylamide, N,N-dimethyl (meth)acrylamide, N-isopropyl (meth)acrylamide, N-tert-butyl (meth)acrylamide, N-tert-octyl (meth)acrylamide, diacetone (meth)acrylamide, vinyl propionate, vinyl 2-ethylhexanoate, N-vinylamides such as: N-vinylpyrrolidione, N-vinylcaprolactam, N-vinylformamide, and N-vinylacetamide, methyl vinyl ether, 2-phosphate ethylene methacrylate, 2-sulphoethylene methacrylate, ethyl vinyl ether, butyl vinyl ether, hydroxybutyl vinyl ether, and styrene; and
(b) at least one second monomer selected from: acrylic acid, methacrylic acid, itaconic acid, maleic acid, fumaric acid, butyl methyl maleate, vinyl sulfonic acid 2-acrylamido-2-methylpropane sulfonic acid, styrene sulfonic acid, vinyl phosphonic acid, vinylbenzenesulphonic acid, α-acrylamidomethyl propanesulphonic acid, allyl phosphonic acid, and salts of any thereof.

12. The latex composition of claim 8 wherein the at least one ethylenically unsaturated monomer comprises:
(a) a first monomer selected from vinyl acetate; and
(b) at least one second monomer selected from: acrylic acid, methacrylic acid, maleic acid, fumaric acid, butyl methyl maleate, vinyl sulfonic acid, 2-acrylamido-2-methylpropane sulfonic acid, styrene sulfonic acid, vinyl phosphonic acid, vinylbenzenesulphonic acid, α-acrylamidomethyl propanesulphonic acid, allyl phosphonic acid, and salts of any thereof.

13. The latex composition of claim 8 wherein the at least one ethylenically unsaturated monomer comprises:
(a) a first monomer selected from vinyl acetate; and
(b) at least one second monomer different from the first monomer.

14. The aqueous composition of claim 1 further comprising at least one additive selected from the group consisting of dispersants, surfactants, rheology modifiers, defoamers, thickeners, biocides, mildewcides, colorants, waxes, perfumes and co-solvents.
